(19) United States
(12) Patent Application Publication
(10) Pub. No.: US 2007/0175984 A1
(43) Pub. Date: Aug. 2, 2007

(54) OPEN-LOOP GIFT CARD SYSTEM AND METHOD

(75) Inventors: Omar F. Khandaker, Las Vegas, NV (US); Rick L. Willard, Las Vegas, NV (US)

Correspondence Address: AXIOS LAW GROUP, 1725 WESTLAKE AVENUE NORTH, SUITE 150, SEATTLE, WA, 98109, US

(73) Assignee: WOW! Technologies, Inc., Las Vegas, NV (US)

(21) Appl. No.: 11/626,130

(22) Filed: Jan. 23, 2007

Related U.S. Application Data
(63) Continuation-in-part of application No. 10/905,989, filed on Jan. 28, 2005.
(60) Provisional application No. 60/766,521, filed on Jan. 24, 2006.

(51) Int. Cl. G06K 5/00; G06Q 40/00

(52) U.S. Cl. 235/380; 705/41

(57) ABSTRACT

Provided herein is a description of an open-loop gift card system and method.

### CROSS-REFERENCE TO RELATED APPLICATION

This application is a continuation-in-part of U.S. patent application Ser. No. 10/905,989, entitled ONLINE PAYMENT SYSTEM AND METHOD, with the named inventors Rick L. Willard and Omar F. Khandaker, filed on Jan. 28, 2005; and claims the benefit of U.S. patent application Ser. No. 60/766,521, entitled OPEN-LOOP GIFT CARD SYSTEM AND METHOD, with the named inventors Rick L. Willard and Omar F. Khandaker, filed on Jan. 24, 2006 which are hereby incorporated by reference.

### FIELD

The present invention generally relates to debit cards and, more particularly, to gift debit cards.

### BACKGROUND

Debit cards and closed-loop (i.e., not using generally available debit card networks) gift cards are well known in the art. Such cards are typically linked to a user's bank account or are purchased from a vendor and come in fixed value increments, for example, $10, $20, and $50. A $10 card provides the customer with $10 of purchasing power utilizing an existing debit card system. In the operation of prior art systems, cards are batch activated by the card provider in a limited number of predetermined values. A customer purchases one of these pre-activated cards by paying a fee. The cards typically include a predetermined identification code.

Such systems have proved commercially successful and desirable for a number of reasons. Gift cards allow customers to present recipients of gifts with a convenient and easy to use payment mechanism. However, once the card has been used by the recipient, its usefulness is exhausted, and it is generally thrown away.

Additionally, many merchants have little or no incentive to sell cards, and neither do other parties in the supply chain system. Current debit card and gift card technologies do not allow for distributing fees associated with these cards to a wide audience to create incentives to distribute the cards.

Furthermore, many debit cards are limited in the types of financial transactions (and networks) they may employ.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a pictorial diagram of a number of interconnected devices that provide a connected point of sale device card loading functionality in accordance with embodiments of the present invention.

FIG. 2 is a block diagram of a card managing server device that provides an exemplary operating environment for an embodiment of the present invention.

FIG. 3 is an exemplary diagram of a point-of-sale device that provides an exemplary operating environment for an embodiment of the present invention.

FIG. 4 is an exemplary diagram of a loadable debit card in accordance with embodiments of the present invention.

FIG. 5 is a diagram illustrating the actions taken by devices in a loadable debit card system for loading value to a loadable debit card in accordance with embodiments of the present invention.

FIG. 6 is a flow diagram illustrating a card loading routine in accordance with embodiments of the present invention.

FIG. 7 is a diagram illustrating the actions taken by devices in a loadable debit card system for activating a loadable debit card in accordance with embodiments of the present invention.

FIG. 8 is a flow diagram illustrating a card activation routine in accordance with embodiments of the present invention.

FIG. 9 is a diagram illustrating the actions taken by devices in a loadable debit card system to settle payment and fees in accordance with embodiments of the present invention.

FIG. 10 is a flow diagram illustrating a settlement routine in accordance with embodiments of the present invention.

FIG. 11 is a diagram illustrating loadable debit card fee distributions in accordance with embodiments of the present invention.

FIG. 12 is a diagram illustrating the actions taken by devices in a loadable debit card system to access an account statement in accordance with embodiments of the present invention.

FIG. 13 is a flow diagram illustrating a card account statement routine in accordance with embodiments of the present invention.

FIG. 14 is a pictorial diagram of a number of interconnected devices that provide a connected user device online payment and transfer functionality in accordance with embodiments of the present invention.

FIG. 15 is a diagram illustrating the actions taken by devices in a loadable debit card system to pay for goods or services in accordance with embodiments of the present invention.

FIG. 16 is a flow diagram illustrating an online card payment routine in accordance with embodiments of the present invention.

FIG. 17 is a diagram illustrating the actions taken by devices in a loadable debit card system for loading value in a merchant debit card in accordance with embodiments of the present invention.

FIG. 18 is a flow diagram illustrating a merchant card loading routine in accordance with embodiments of the present invention.

FIG. 19 is a diagram illustrating the actions taken by devices in a loadable debit card system to transfer value from a loadable debit card to a bank account in accordance with embodiments of the present invention.

FIG. 20 is a flow diagram illustrating a card transfer routine in accordance with embodiments of the present invention.

FIG. 21 is a diagram illustrating the actions taken by devices in a debit card system for transferring value from one bank account to another bank account in accordance with embodiments of the present invention.

FIG. 22 is a flow diagram illustrating an inter-bank transfer routine in accordance with embodiments of the present invention.

FIG. 23 is a pictorial diagram of a number of interconnected devices that provide ACH transactions in accordance with embodiments of the present invention.

FIG. 24 is a diagram illustrating the actions taken by devices in an ACH transaction system to perform actions in accordance with embodiments of the present invention.

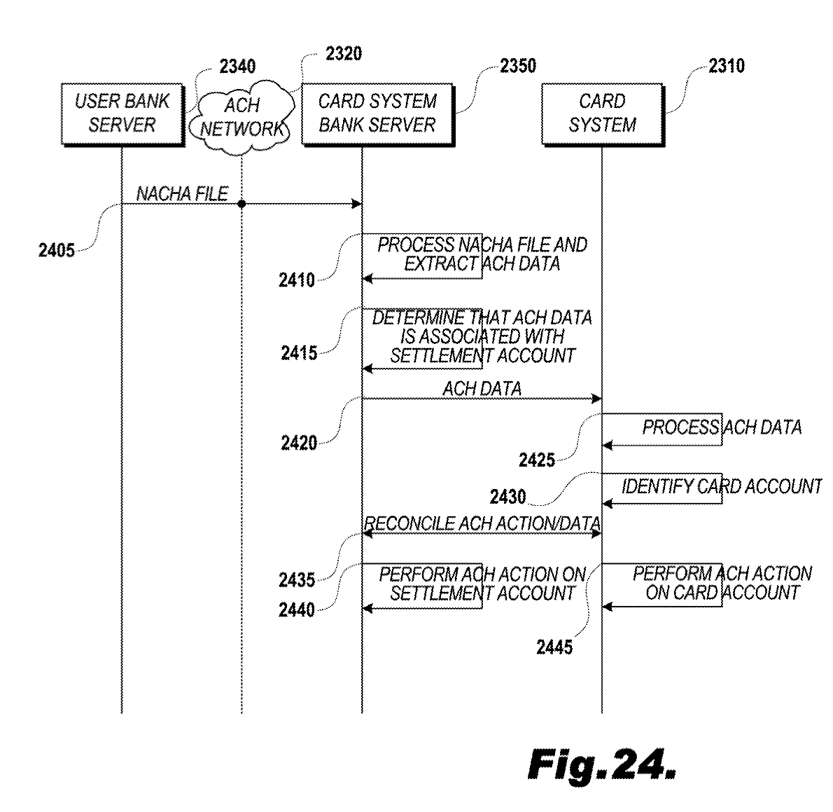

FIG. 25 is a flow diagram illustrating an ACH transaction process on a bank server in accordance with embodiments of the present invention.

FIG. 26 is a diagram illustrating the actions taken by devices in an ACH transaction system to transfer funds in accordance with embodiments of the present invention.

FIG. 27 is a diagram illustrating the actions taken by devices in an ACH transaction system to perform multiple ACH transactions in accordance with embodiments of the present invention.

FIG. 28 is a flow diagram illustrating ACH data processing subroutine in accordance with embodiments of the present invention.

FIG. 29 is a diagram illustrating some components and steps for funding an open-loop gift card via an open-loop network.

FIG. 30 is a diagram illustrating some components and steps for funding an open-loop gift card via a closed-loop network.

### DETAILED DESCRIPTION

Attached are figures illustrating embodiments of the present invention. Those of ordinary skill in the art will appreciate that other embodiments, including additional devices, or combinations of illustrated devices, may be added to or combined in the present invention without changing the spirit or scope of the present invention.

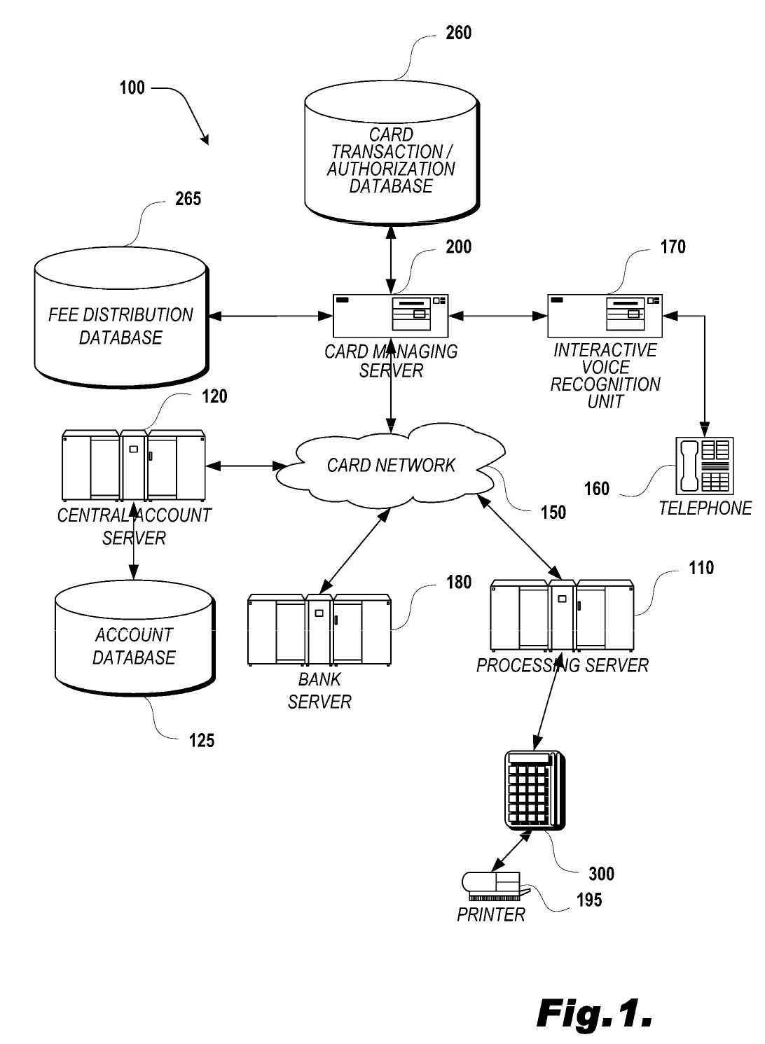

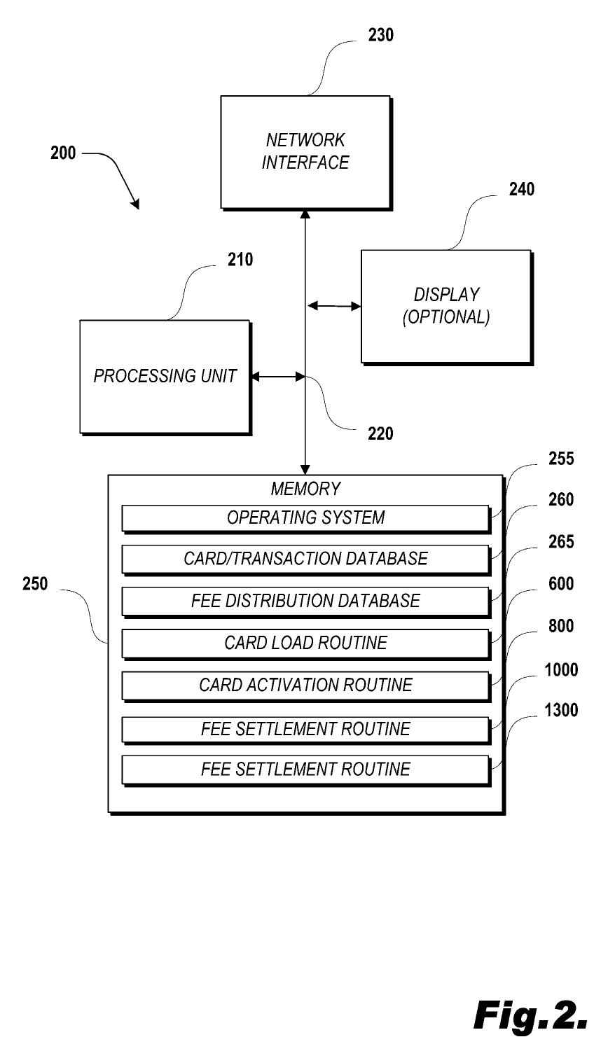

FIG. 1 illustrates an exemplary embodiment of a number of devices used in an exemplary embodiment of the present invention. FIG. 1 illustrates point-of-sale terminals 300 (optionally having a printer 195) connected to a processing server 110, which controls the interactions of the point-of-sale terminals 300 and a card network 150, such as a network provided by any of the well known debit/credit card transaction network providers (e.g., Star, Cirrus, Visa, MasterCard, American Express, Diners Club, etc.). Also in communication with the card network 150 is a central account server 120, having an account database 125 for managing individual card accounts. It will be appreciated by one of ordinary skill in the art that there may be a plurality of central account servers for managing account databases 125, or even that the role of the central account server 120 may be performed by another device such as bank server 180. Additionally, connected to the card network 150 is a card managing server 200, illustrated in FIG. 2 and described below. However, illustrated in FIG. 1 the card managing server 200 also includes a card transaction/authorization database 260, which maintains information about individual cards and the transactions associated with them, and a fee distribution database 265 for determining how card fees will be distributed. It will be appreciated by those of ordinary skill in the art and others that the card transaction/authorization database 260 and fee distribution database 265 may comprise a plurality of databases or may be a single database. Additionally, in communication with the card managing server 200 is an interactive voice recognition unit (“IVRU”) 170 connected to a telephone 160 for communication between a user and the card managing server 200. It will be appreciated by one of ordinary skill in the art that the telephone 160 may be connected to the IVRU 170 via any conventional telephone connection such as through a publicly-switched telephone network (not shown).

FIG. 2 illustrates several of the key components of the card managing server 200. Those of ordinary skill in the art will appreciate that the card managing server 200 may include many more components than those shown in FIG. 2. However, it is not necessary that all of these generally conventional components be shown in order to disclose an illustrative embodiment for practicing the present invention. As shown in FIG. 2, the card managing server 200 includes a network interface 230 for connecting to the card network 150. Those of ordinary skill in the art will appreciate that the network interface 230 includes the necessary circuitry for such a connection and is constructed for use with the appropriate protocol.

The card managing server 200 also includes a processing unit 210, may include an optional display 240, and a memory 250, all inter-collected along with the network interface 230 via a bus 220. The memory 250 generally comprises a random access memory (“RAM”), a read-only memory (“ROM”), and a permanent mass storage device, such as a disk drive. The memory 250 stores the program code necessary for a card real-time load routine 600, a card activation routine 800, a fee settlement routine 1000 and a statement retrieval routine 1300, in addition to the card transaction/authorization database 260 and fee distribution database 265. In addition, the memory 250 also stores an operating system 255. It will be appreciated that these software components may be loaded from a computer-readable medium into memory 250 of the card managing server 200 using a drive mechanism (not shown) associated with a computer-readable medium, such as a floppy disc, tape, DVD/CD-ROM drive or via the network interface 230.

Although an exemplary card managing server 200 has been described that generally conforms to conventional general purpose computing devices, those of ordinary skill in the art will appreciate that a card managing server may be any of a great number of devices capable of communicating with the card network 150 or with the interactive voice recognition unit 170.

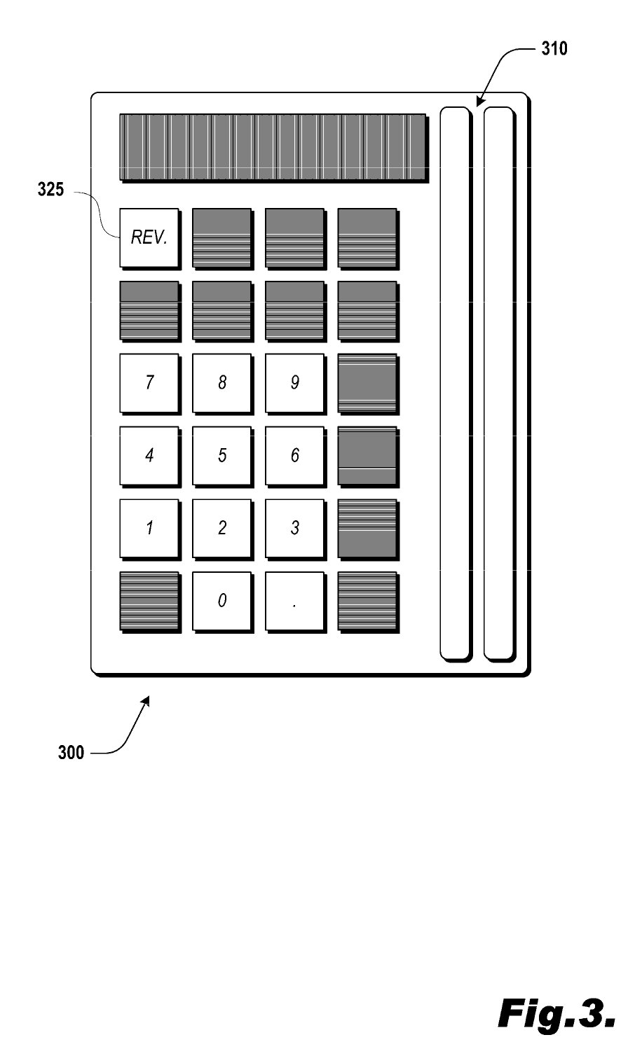

FIG. 3 depicts an exemplary point-of-sale (“POS”) device 300 for use in the present invention. The POS device 300 includes a card reader 310 and a transaction reversal button 325. Although an exemplary POS device 300 has been described and shown in FIG. 3, those of ordinary skill in the art will appreciate that POS devices may take many forms and may include many additional components other than those shown in FIG. 3. For example, the POS device 300 may include a connection to a printer 195 for printing information received at the POS device 300.

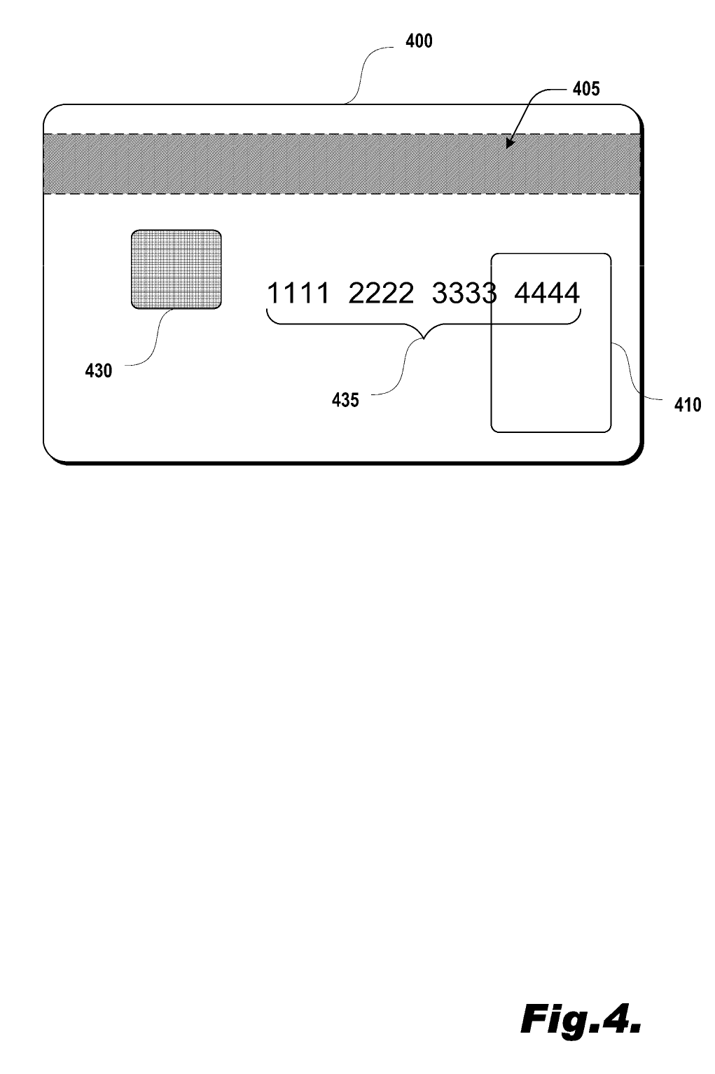

FIG. 4 illustrates an exemplary card 400, such as a loadable debit card in accordance with the present invention. The card 400 may include a magnetic strip 405, a smart card chip interface 430, embossed account numbers 435 and/or fraud prevention components 410 (e.g., decals, photographs, holograms, etc.). It will be appreciated by those of ordinary skill in the art that the card 400 may include any of the magnetic strip 405, smart card chip interface 430, and embossed numbers 435 to be effective as a loadable debit card. It will further be appreciated that additional ways of storing information or providing information on the card may also be used. In one exemplary embodiment, a security code may be printed or embossed on the card 400 as well.

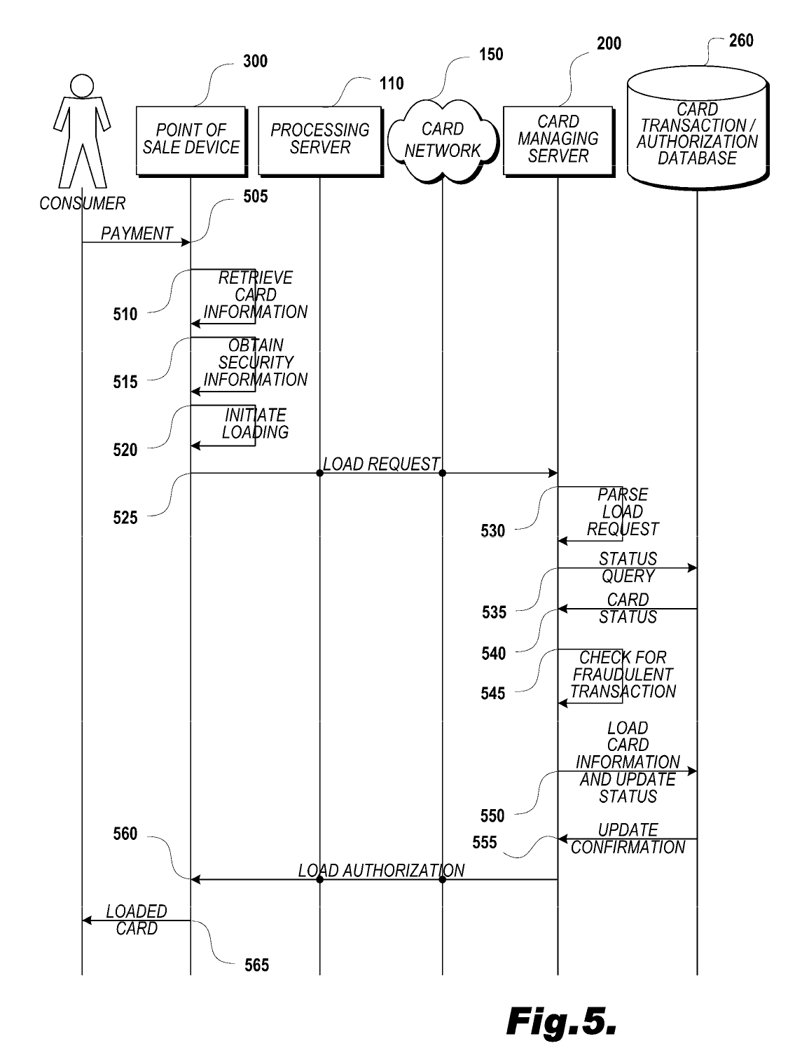

FIG. 5 illustrates steps taken to load a value in real-time onto the loadable debit card 400 in accordance with the present invention. A user provides payment 505 to a merchant with a POS device 300. The merchant using the POS device 300 will then retrieve a card and retrieve card information 510 (e.g., an account number) from the card 400. Next, merchant security information is obtained 515, either by the merchant, automatically by the POS device 300 or a combination of both. In one exemplary embodiment, the merchant enters a merchant PIN and the POS device 300 has a POS identification number that are both used as security information. After the security information is obtained 515, the merchant initiates a loading transaction 520 (real time debit return with a pin, debit correction, or debit reversal with transaction code) at their POS device 300. Loading transactions of the present invention are those transactions that normally take place when a refund is being issued to an existing debit card. However, in prior art systems, these transactions were unavailable for loading gift cards or private debit cards, such as card 400. Prior art systems would reject such transactions at the card network level. In accordance with the present invention, the merchant with the POS device 300 has activated the POS device 300 in such a way with the card network 150 as to allow loading transactions to be initiated for loading values onto debit cards in accordance with the present invention. In one exemplary embodiment, the activation of the POS device 300 includes obtaining approval from a card network provider to allow such transactions. The load request (of a designated amount) from the POS device 300 is then communicated to a processing server 110, which forwards it, via the card network 150, to the card managing server 200. Once the card managing server 200 receives the load request 525, it is parsed 530 to determine the card information, the POS and processors' information, and the amount of the transaction. A status query 535 is sent to the card transaction/authorization database 260 to determine the current status of the card and its associated account and the current status is then returned 540 to the card managing server 200. Next, the transaction is checked for any fraudulent activity 545 or errors in the transaction. The security information gathered at the POS device 300 is checked, along with the account number of the card 400, to ascertain that the transaction is a legitimate loading transaction. Those of ordinary skill in the art and others will appreciate that a variety of security verification checks may be implemented with such information. Assuming no fraud or errors are present in the transaction, the card information is loaded 550 to a card transaction/authorization database 260. Once the card information has been loaded and updated at the card transaction/authorization database 260, the card managing server 200 receives an update confirmation 555 from the card transaction/authorization database 260. The card managing server 200 then sends a load authorization 560 back, via the card network 150 and the processing server 110, to the POS device 300. Once the merchant receives the authorization at their POS device 300, they then provide 565 the card 400 to the user as a loaded card.

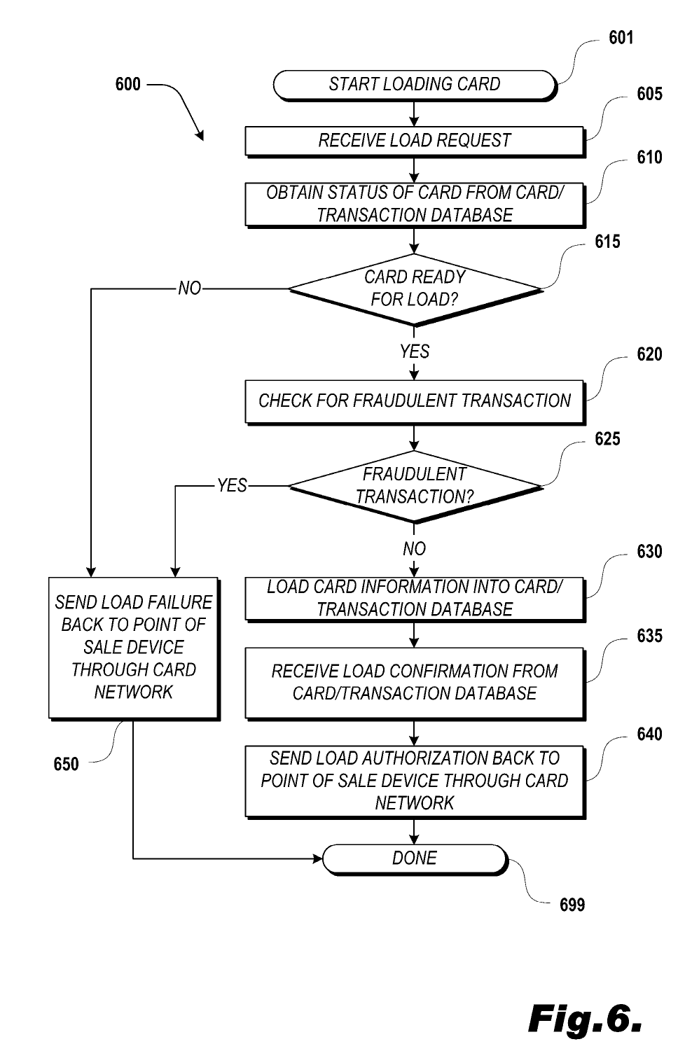

FIG. 6 illustrates an exemplary card loading routine from the view of the card managing server 200. The card loading routine beings in block 601 and proceeds to block 605 where it receives a load request. Next, in block 610, the status of the card is obtained from the card transaction/authorization database 260. Next, in decision block 615, a determination is made whether the status of the card with the card transaction/authorization database 260 indicates that the card is ready for loading. If it was found in decision block 615 that the card was not ready for loading, a load error is sent back to the POS device 300 through the card network 150 in block 650 and processing ends at block 699. Otherwise, if in decision block 615 a determination is made that the card is ready for loading, then, in block 620, the card managing server 200 checks for fraudulent transactions or errors in the transaction. Security information included in the load request (e.g., merchant PIN and POS device 300 identification) is checked, along with the account number of the card 400, to ascertain that the transaction is a legitimate loading transaction. Those of ordinary skill in the art and others will appreciate that a variety of security verification checks may be implemented with such information. Next, in decision block 625, a determination is made whether any errors or fraudulent aspects are found in the transaction and, if they were found, then processing continues to block 650. Otherwise, if no errors or fraudulent indications were found for the transaction, then, in block 630, the card information, along with the information in the load request (e.g., load amount, processor information, and point of sale information), is loaded into the card transaction/authorization database 260. In block 635, the card managing server 200 receives a confirmation that the card information has been loaded and updated in the card transaction/authorization database. Once the load has been confirmed, then, in block 640, the card managing server sends the load authorization back to the POS device 300, via the card network 150 and the processing server 100. Routine 600 then ends at block 699.

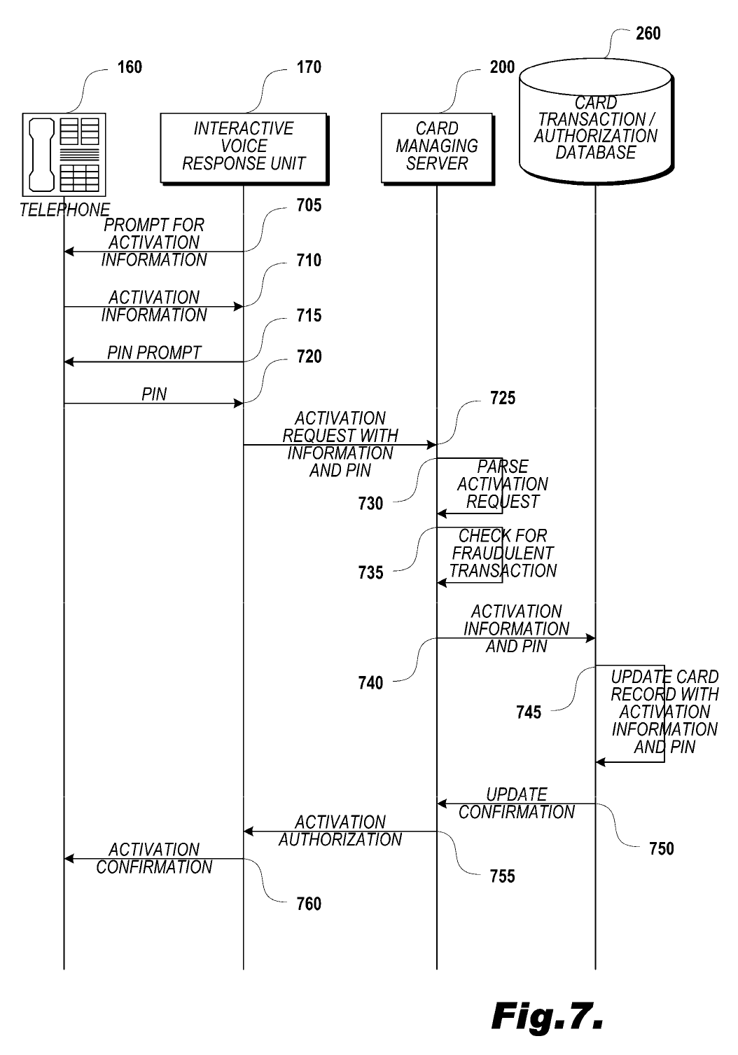

To better illustrate the operation of activating the loaded debit card of the present invention, FIG. 7 illustrates one exemplary embodiment of the actions performed by a system for activating the loadable debit card. The system of FIG. 7 includes a telephone 160 and interactive voice response unit 170, a card managing server 200 and a card transaction/authorization database 260. Upon connection with the interactive voice response unit 170, the telephone 160 receives a prompt 705 for activation information. The customer enters activation information 710 (e.g., account number, security code and possibly other optional registration information, such as a customer name and contact information) into the telephone 160 via voice, rotary, touch tone or other technology known to those of ordinary skill in the art. Upon receipt of the activation information, the interactive voice response unit 170 requests 715 a personal identification number (“PIN”). The customer may then enter a PIN 720 via voice, rotary, touch tone or other means using the telephone 160. Once the IVRU 170 has received the PIN it forwards an activation request 725 with the activation information and PIN to the card managing server 200. The card managing server parses 730 the activation requests to extract the relevant card information and PIN number and checks for any fraudulent transactions 735 or errors in the activation request (e.g., by determining if an initial transaction was performed to load value onto the card 400). Assuming that no fraud or errors are found then the activation information and PIN is forwarded 740 to the card transaction/authorization database 260 where the appropriate card record is updated 745 with the activation information and PIN and marked as activated. The update is confirmed 750 back to the card managing server 200 which then sends the activation authorization 755 to the interactive voice response unit 170. The interactive voice response unit 170 may then send activation confirmation 760 to the customer, via the telephone 160, either contemporaneously with the activation requests or at a later point. It will be appreciated by those of ordinary skill in the art that other activation methods may also be employed such as via messaging systems and/or data communications over a network. Such alternate systems would operate in a similar manner, but substitute alternate communication devices instead of a telephone 160 and IVRU 170.

It will be appreciated, that in alternate embodiments, other forms of activation may be employed. For example, a user may call a customer service center and activate their loadable debit card with a customer service agent. Still other conventional activation techniques may be used as well, such as activating via a Web page or the like.

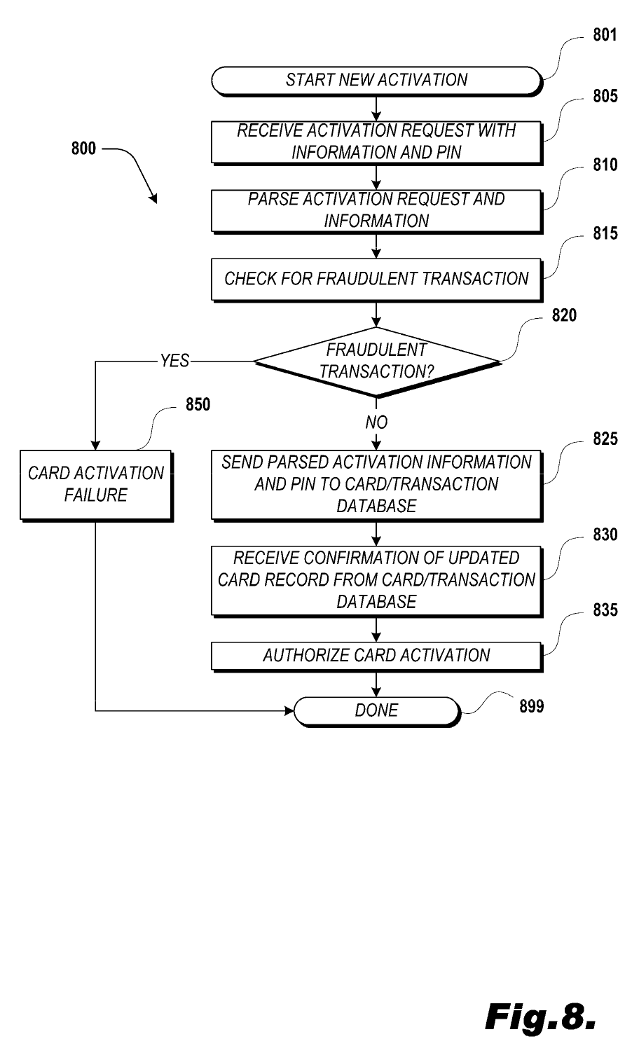

A flow chart illustrating an exemplary activation routine 800 implemented by the card managing server 200 is shown in FIG. 8. The activation routine 800 begins at block 801 and proceeds to block 805 where an activation request is received with activation information and a PIN. Next, in block 810, the activation request is parsed to retrieve relevant information including the activation information and the PIN. The activation information may include any form of information that would be appropriate for activating the loadable debit card, such as the numbers embossed on the front of the card with an additional set of numbers (e.g., a security code) that may be provided separately or printed in alternate placement on the card such as on the reverse side of the card. Additionally, the PIN information will be selectable by the user or, in one alternate embodiment, may be assigned at the time of loading by a merchant and provided to the user as a further means of authentication during activation. The flow of routine 800 continues to block 815 where the activation transaction is checked for any fraudulent or flawed components. If no flaws, errors or fraudulent indicators were found in decision block 820, processing continues to block 825. Otherwise, if a flaw, error or fraudulent indicator was found then, in block 850, a card activation failure is sent out by the card managing server 200 and routine 800 ends at block 899. Back in block 825 the card managing server 200 sends the parsed activation information and PIN to the card transaction/authorization database 260. Next, in block 830, the card transaction/authorization database 260 sends back a confirmation of the updated card record which is received by the card managing server 200. Routine 800 then continues to block 835 where the card activation is authorized and routine 800 then ends at block 899.

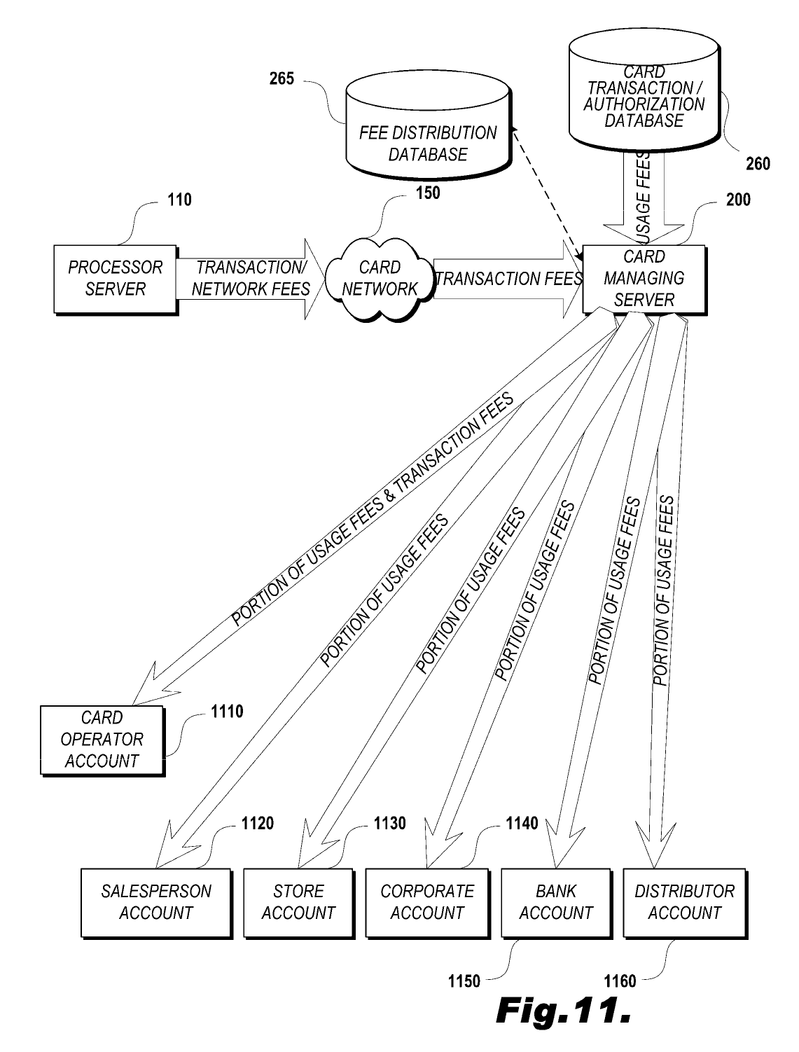

In the past, debit cards only had transaction fees associated with the use of the card and their associated account may have had banking fees that were unrelated to the use of the card (i.e., the banking fees would have been charged regardless of whether the card had a balance, was present, used, or not used). These previous transaction fees typically only benefited either a merchant or a bank or, in the case of an ATM machine, the ATM's bank or the ATM's operator. Accordingly, debit cards were typically only used in the past by banking institutions that could collect these collateral transaction fees. Some merchants did issue their own debit “gift” cards, however, these usually were limited to use within a particular merchant's store or stores. As all the transaction fees and/or costs associated with the card went to the merchant, there was no incentive for other merchants or banks to recognize these cards. However, the card system of the present invention does not merely limit the incentives to transaction fees associated with the card; rather, there is a card account fee that is charged to the cardholder so long as they carry a balance on the card. In one exemplary embodiment this is a $0.25 per day charge, such that on any given day that there is a balance on the card up to $0.25 is deducted per day from that card account. If the balance is less than $0.25 on any given day, then the card account has the total balance deducted and thereafter has no account fees taken from the card account until there is a balance again on the card account. Using such a $0.25 per day fee equates to approximately $7.50 a month, not dissimilar from conventional banking charges for standard accounts. However, unlike conventional bank accounts, the fees collected from the card are distributed to a number of different entities in accordance with the present invention. FIG. 11 illustrates one exemplary breakdown of the fee distribution system; however, those of ordinary skill in the art will appreciate that any number of fee distribution systems may be utilized, either with more or fewer entities receiving fees as appropriate under market conditions.

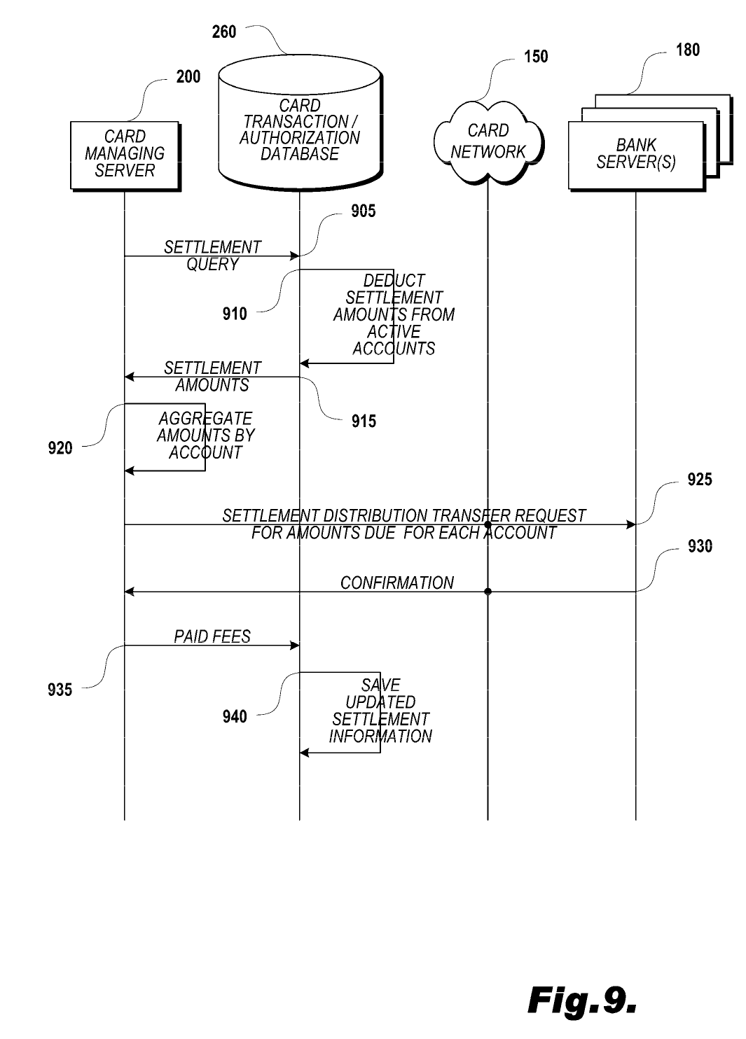

In addition to loading and activating the loadable debt card 400, the present invention allows for the settling of transactions and the distribution of fees associated with the use of the loadable debit card 400. To better illustrate the settlement operations, FIG. 9 illustrates one exemplary embodiment of actions performed by a system for settling transactions. The system of FIG. 9 includes the card managing server 200, the card transaction/authorization database 260, the card network 150 and bank server or servers 180. The settlements are periodically performed and are initiated when the card managing server 200 sends a settlement query 905 to the card transaction database 260 to determine which transactions and fees are ready for settlement. This may occur at regular time intervals or, in one embodiment, when sufficient transactions have reached a level where the settlement transaction will be of a predetermined size (e.g., if at least $100,000 in fees will be distributed). In another embodiment settlement queries 905 may happen more often, but only accounts receiving over a predetermined amount are used for queries. For example, if the account only is due $0.10, it is not reported until the amount due reaches some threshold, such as $10. The settlement amounts are deducted from active accounts identified at the card transaction/authorization database 260. The card transaction database 260 returns 915 a listing of the settlement amounts which are ready of settlement. The card managing server 200 then aggregates 920 settlement amounts for the payment transactions received from the card transaction database 260 and the fees for balances on cards, and aggregates the payments and fees by account, as provided in the fee distribution database 265 (not shown in FIG. 9). The aggregated payments and fees are then forwarded 925, via the card network 150, to a bank server 180 for transfer to the appropriate accounts. It will be appreciated by one of ordinary skill in the art and others that these payments may be sent to a bank server 180 if the bank server 180 is managing the accounts. If there is a plurality of different institutions managing the accounts for which payments and fees are to be sent then, in another embodiment, the central account server 120 may receive the settlement transfer requests and forward them to different banking servers, as determined from its account database 125. However, in one exemplary embodiment illustrated in FIG. 9, a single bank server 180 is used. Once the settlement transfer requests have been received and processed by the bank server 180 a confirmation 930 is returned, via the card network 150, to the card managing server 200. The card managing server 200 then sends 935 the list of completed settlement transactions back to the card transaction/authorization database 260, where the updated settlement information is saved 940.

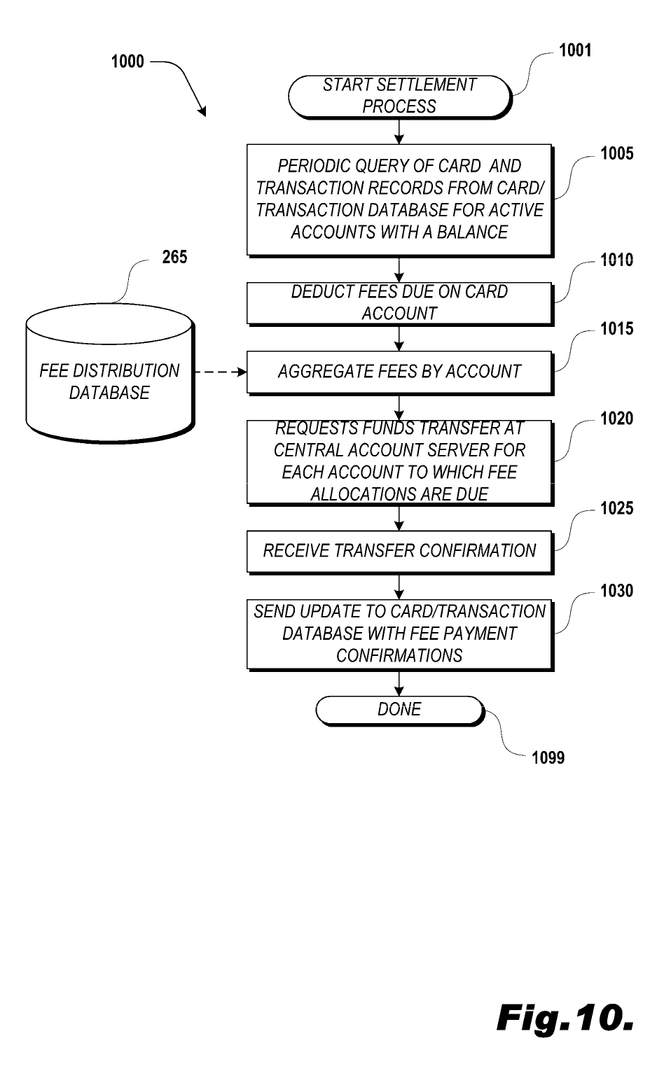

Much as illustrated in FIG. 9, FIG. 10 illustrates the settlement process from the point of view of the card managing server 200. Settlement routine 1000 starts at block 1001 and proceeds to block 1005 where the transaction records for the periodic settlement are retrieved from the card transaction/authorization database 260. Next, in block 1010, the fees due on payment transactions and payments due to particular accounts are determined. Then, in block 1015, the payments and fees are aggregated by account (assisted by the fee distribution database 265) to minimize the number of transactions requested from the server in charge of accounts. In block 1020, the funds transfer request is sent for all the accounts for which funds are due, including payments and fees. Block 1020 may send the funds transfer request either to a bank server 180 or the funds transfer requests may be send to a central account server which will manage the transfers to a plurality of banking servers. The funds transfer requests are confirmed upon completion which is received in block 1025. Next, in block 1030, the card managing server 200 sends an update to the card transaction/authorization database 260 indicating that all the completed transactions were received from the confirmation in block 1025. Routine 1000 then ends at block 1099.

FIG. 11 illustrates one exemplary fee distribution system illustrating the collecting and distribution of fees in accordance with the present invention. For purposes of simplicity, only two types of fees are illustrated in FIG. 11, usage fees and transaction fees. The transaction fees are those fees that are associated with debit card transactions in a conventional debit card network, such as merchant fees, card network fees, and/or banking fees. For example, if a user were to pay for $10 of gasoline at a gas station with a surcharge for using debit cards, there would be a $0.25 surcharge that goes to the gas station, e.g., the merchant, which is collected at their process server 110. Next, there would be a card network fee, which is usually a fixed amount plus a percent of a transaction, in this case, perhaps $0.10 plus 2% of the transaction, which is another $0.30 and that $0.30 is distributed between the card network and the banking institution or institutions involved according to conventional mechanisms in the debit card system. So, accordingly, in FIG. 11 we see a process server 110 sending transaction and network fees to a card network 150. The card network “absorbs” the network fees and passes on any remaining transaction fees to the card institution in this invention, represented by the card managing server 200. The card managing server sends those transaction fees to a card operator account 1110. However, in addition to the conventional transaction fees associated with a debit card, there are the usage fees, which, in one embodiment of the invention, is $0.25 per day that a card carries a balance. Accordingly, once a day a query is run on the card transaction database 260 and the usage fees are calculated and sent to the card managing server 200, which then distributes a portion of the usage fees to various accountholders. In one exemplary embodiment shown in FIG. 11 a portion of the usage fees goes to the card operator account 1110, a salesperson account 1120, a store account 1130, a corporate account 1140, a bank's account 1150, and a distributor account 1160. Of course, more or fewer accounts may be used in alternate embodiments. Those of ordinary skill in the art will appreciate that although the singular is used when describing accounts, the plural applies as well in that there may be a multitude a salesperson accounts 1120, store accounts 1130, corporate accounts 1140, banks' accounts 1150, and distributor accounts 1160. However, it is generally anticipated that there will be a smaller number of card operator accounts 1110, possibly even only a single card operator account 1110.

In one exemplary embodiment the $0.25 fee is distributed proportionately as follows: The salesperson/people get $0.03 to the salesperson account 1120, the merchant gets $0.05 to the store account 1130, the corporation owning the store gets $0.03 to the corporate account 1140, the bank gets $0.01 to the bank's account 1150 and the distributor gets $0.01 for the distributor account 1160. The remaining $0.12 goes to the card operator account 1110. Other distributions and parties may be used in other embodiments. For example, if the company owning the merchant's store has over one million cards they may get a higher share (perhaps $0.05).

While the distribution of the usage fees is shown as going to a particular account, the card managing server utilizes the fee distribution database 265 to determine exactly which accounts will receive which portion of the usage fees. After which, the share going to that account is transferred using conventional banking systems, such as the Automated Clearing House (“ACH”) transfer system, to transfer the fees to the appropriate account. Such conventional banking systems usually have a cost associated with such a transfer, which is deducted from the amount transferred to the account on a per transfer basis in one embodiment of the present invention.

In another exemplary embodiment of the present invention, certain accounts may elect to receive their transfers on a less frequent basis. Accordingly, the card managing server may view the accountholders' records in the fee distribution database and only initiate a transfer once conditions have been met. In an exemplary embodiment, the condition may be that transfers occur monthly. In another exemplary embodiment, the transfers may only be initiated once a certain threshold of fees, such as $10, $20 or $100, have been aggregated as payable to the accountholder. Those of ordinary skill in the art will appreciate that many combinations and variations of the fee distribution system described above may be made without departing from the spirit and scope of this invention.

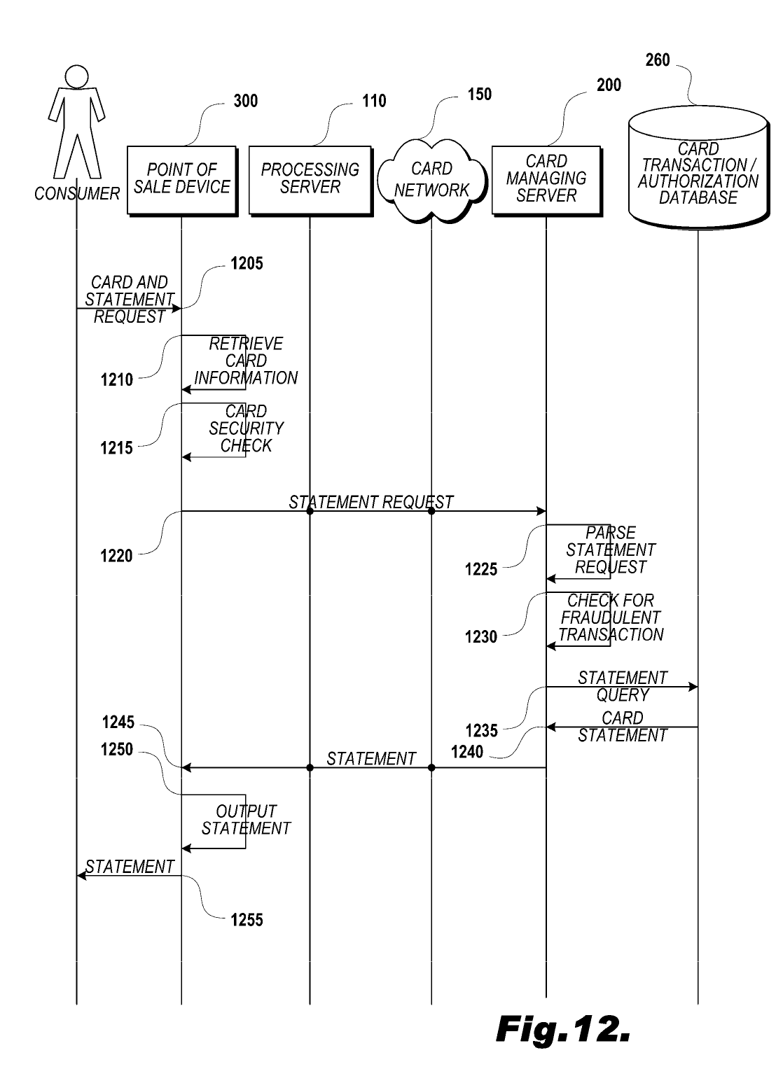

In addition to providing benefits to merchants and operators, the present invention provides additional benefits to users. For example, the present invention allows users to retrieve account statements in an efficient and anonymous manner. FIG. 12 illustrates steps taken to retrieve a statement for the loadable debit card 400. A user requests a statement 1205 from a POS device 300 (or an ATM). The POS device retrieves 1210 card information from the card 400. Next, a card security check 1215 is performed by the POS device 300. Once it is determined that the card 400 is a valid card and has passed the security check, the POS device initiates a statement request 1220 that is communicated to a processing server 110, which forwards it, via the card network 150, to the card managing server 200. Once the card managing server 200 receives the statement request, it is parsed 1225 to determine the card information. Next, the transaction is checked for any fraudulent activity 1230 or errors in the transaction. Assuming no fraud or errors are present in the transaction, the statement query 1235 is sent to card transaction/authorization database 260. The card transaction/authorization database 260 then sends the card statement 1240 to the card managing server 200. The card managing server 200 then sends the statement 1245 back, via the card network 150 and the processing server 110, to the POS device 300. Once the POS device 300 outputs 1250 the statement (either at a display or, optionally, at a printer 195), the user may then retrieve 1255 their statement. In an alternate embodiment, the POS device 300 is supplanted by an Automated Teller Machine (“ATM”) that prints the statement and outputs the statement from an internal printer (not shown).

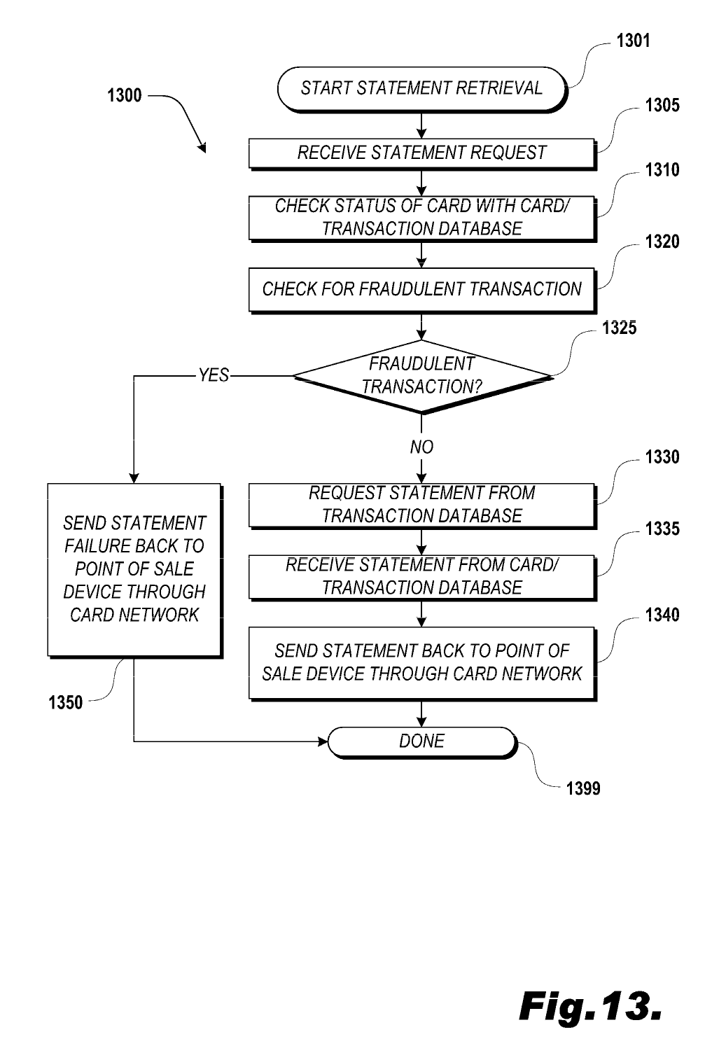

FIG. 13 illustrates an exemplary statement retrieval routine from the view of the card managing server 200. The statement retrieval routine beings in block 1301 and proceeds to block 1305 where it receives a statement request. Next, in block 1310, the status of the card is checked with the card transaction/authorization database 260, to determine whether the status of the card with the card transaction/authorization database 260 indicates that the card is ready for loading. Then, in block 1320, the card managing server 200 checks for fraudulent transactions or errors in the transaction. Next, in decision block 1325, a determination is made whether any errors or fraudulent aspects were found in the transaction and, if they were found, then processing continues to block 1350 where an error is sent back to the POS device through the card network and processing ends at block 1399. Otherwise, if no errors or fraudulent indications were found for the transaction, then, in block 1330, a statement request is sent to the card transaction/authorization database 260. Then, in block 1335, the card managing server 200 receives the card statement from the card transaction/authorization database 260. In block 1340, the card managing server sends the statement back to the POS device 300, via the card network 150 and the processing server 110. Routine 1300 then ends at block 1399.

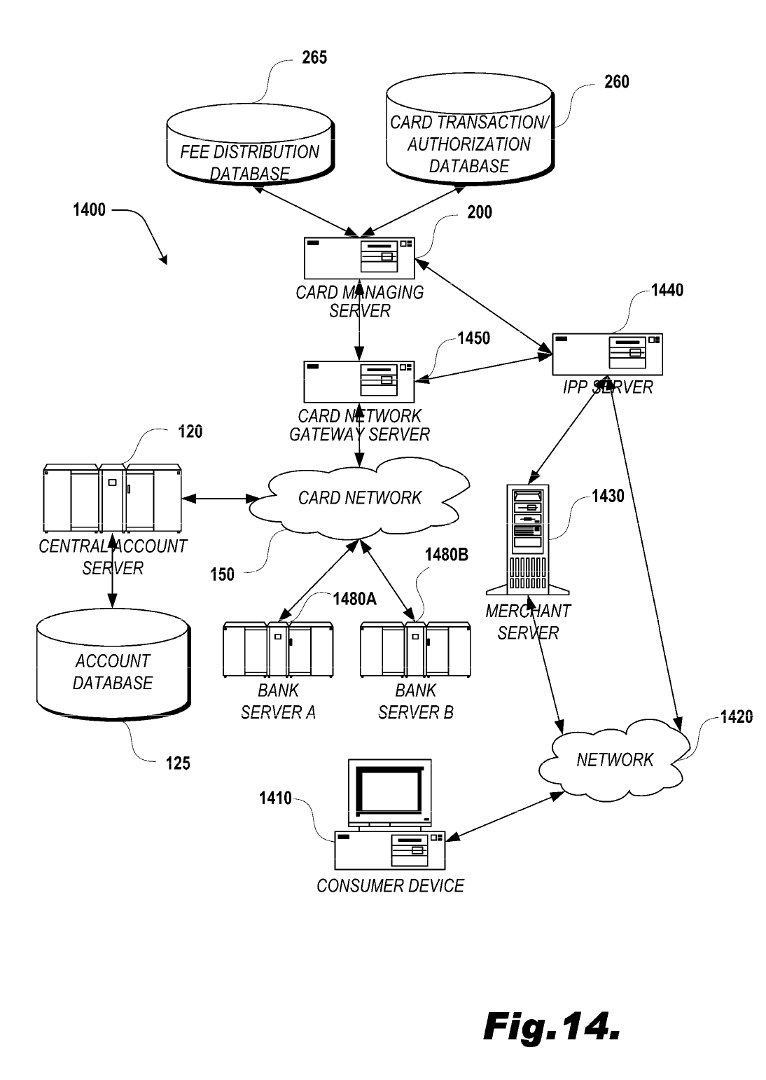

FIG. 14 illustrates an exemplary embodiment of a number of devices used in embodiments of the present invention. FIG. 14 illustrates a user device 1410 connected via a network 1420 to a merchant server 1430 and an Internet Processing Platform (“IPP”) server 1440. The network 1420 may be any form of network that is capable of passing communications between a user device 1410 and the merchant server 1430 and/or IPP server 1440. The merchant server 1430 handles merchant transactions with the user device 1410, e.g., purchasing of goods and/or services. The IPP server serves as an interface to the online payment processing in accordance with embodiments of the present invention. The IPP server 1440 is communicatively linked with a card network gateway server 1450 that serves as an interface to the card network 150. Also communicatively linked to the IPP server is the card managing server 200 illustrated in FIG. 2 and described above. The card managing server 200 includes a card transaction/authorization database 260 and a fee distribution database 265. The card managing server 200 interfaces with the card network gateway server 1450 to communicate with other devices connected to the card network 150. Such other devices include a central account server 120 that includes an account database 125 and bank servers 1480A and 1480B. It will be appreciated by one of ordinary skill in the art and others that more or fewer devices may be present in a system 1400 in an actual embodiment of the present invention. The system 1400 shown on FIG. 14 is meant to illustrate one simplified embodiment of the present invention and is not meant to limit the actual implementations that embodiments of the present invention may form.

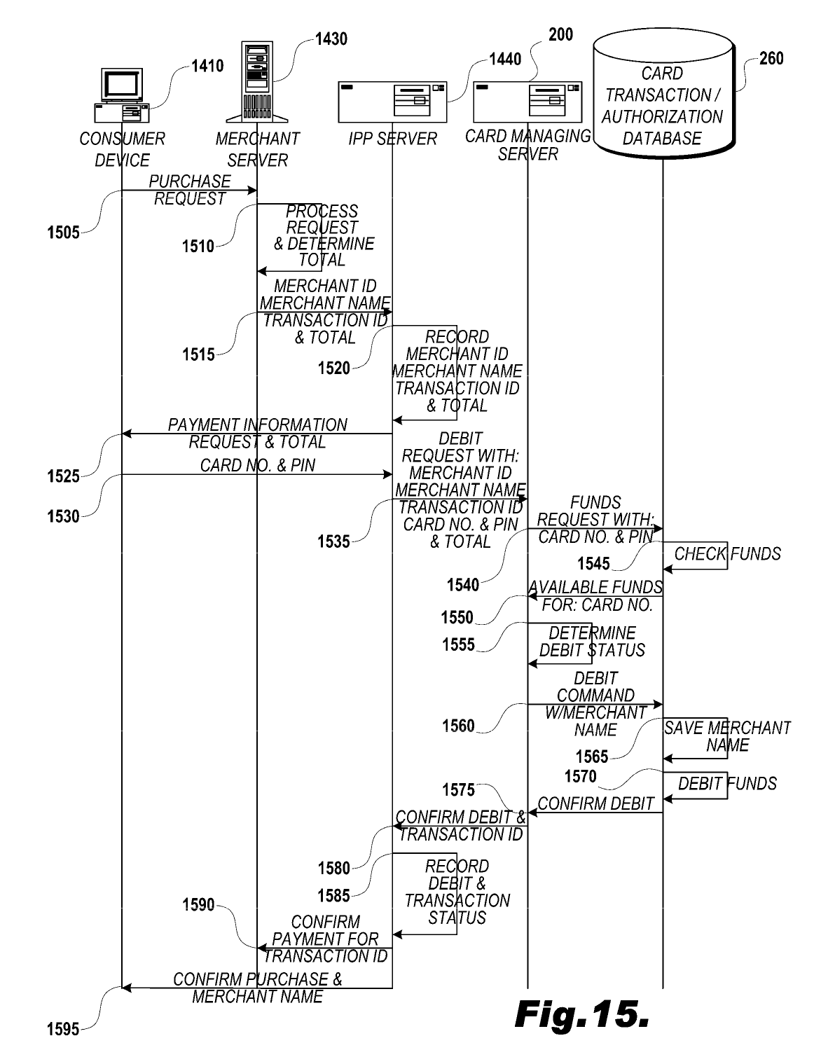

FIG. 15 illustrates communications and interactions between a user device 1410, merchant server 1430, IPP server 1440, card managing server 200 and a card transaction database 260 to process an online payment transaction for goods and/or services provided by a merchant associated with the merchant server 1430. The payment transaction interactions shown in FIG. 15 begin with a purchase request 1505 from the user device 1410 to the merchant server 1430. Once the purchase request 1505 has been received the merchant server 1430 processes the request and determines a total cost 1510 for the transaction. The merchant server 1430 then sends 1515 a merchant identifier, a merchant name, a transaction identifier and a total amount for the transaction to the IPP server 1440. The IPP server 1440 records 1520 the merchant identifier, merchant name, transaction identifier and the total amount for further processing. Next, the IPP server 1440 sends 1525 a payment information request and the transaction total amount back to user device 1410, thereby prompting the user device 1410 to request payment information from a user of the user device 1410. Next, the user device 1410 returns a loadable debit card number and PIN 1530 (or other authentication information, such as biometric identification information, cryptographic handshake information, username and password information, challenge/response information or the like) to the IPP server 1440. Those of ordinary skill in the art and others will appreciate that many forms of card identifiers and authenticating information may be used in accordance with various embodiments of the present invention. In the exemplary embodiment illustrated in FIG. 15 a card number and personal identification number (or other authentication information) are used as card identifying information and authorizing information, respectively. In other embodiments of the present invention a non-numeric card identifier may be used and the authorizing information may be more complex than a PIN number. For example, a challenge response system with a dynamically generated password may be used in further embodiments of the present invention. In yet other embodiments, a biometric indication may be used as authorizing information for the payment transaction of embodiments of the present invention.

Once the IPP server 1440 receives the payment information it sends a debit request 1535 with a merchant identifier, merchant name, transaction identifier, card number, PIN and a total amount of the transaction to a card managing server 200. The card managing server 200 then queries the card transaction database 260 with a funds request 1540 with the card number and PIN. The card transaction database 260 checks 1545 for available funds in an account associated with the card number and the PIN and returns 1550 the available funds associated with that account to the card managing server 200. The card managing server 200 determines whether there are sufficient funds to perform a debit of the transaction total amount from the account associated with the card number and PIN. Assuming that such a determination was positive, processing proceeds at the card managing server with a debit command 1560 sent along with the merchant name to the card transaction database 260. The card transaction authentication database 260 saves the merchant name 1565 and debits the transaction total 1570 from the account associated with the card number and PIN and returns a confirmation 1575 to the card managing server 200. The card managing server 200 confirms the debit and sends the transaction identifier 1580 back to the IPP server 1440. The IPP server 1440 records the debit 1585 and transaction status and confirms the online payment transaction 1590 along with the transaction identifier to the merchant server 1430. Additionally, the IPP server 1440 may also confirm the purchase and merchant name 1595 to the user device 1410.

Those of ordinary skill in the art and others will appreciate that the online payment transaction communications and interactions shown in FIG. 15 are merely illustrative of one exemplary embodiment of the present invention for processing online payment transactions and that other embodiments of the present invention may have different communications and interactions between similar and dissimilar computing devices.

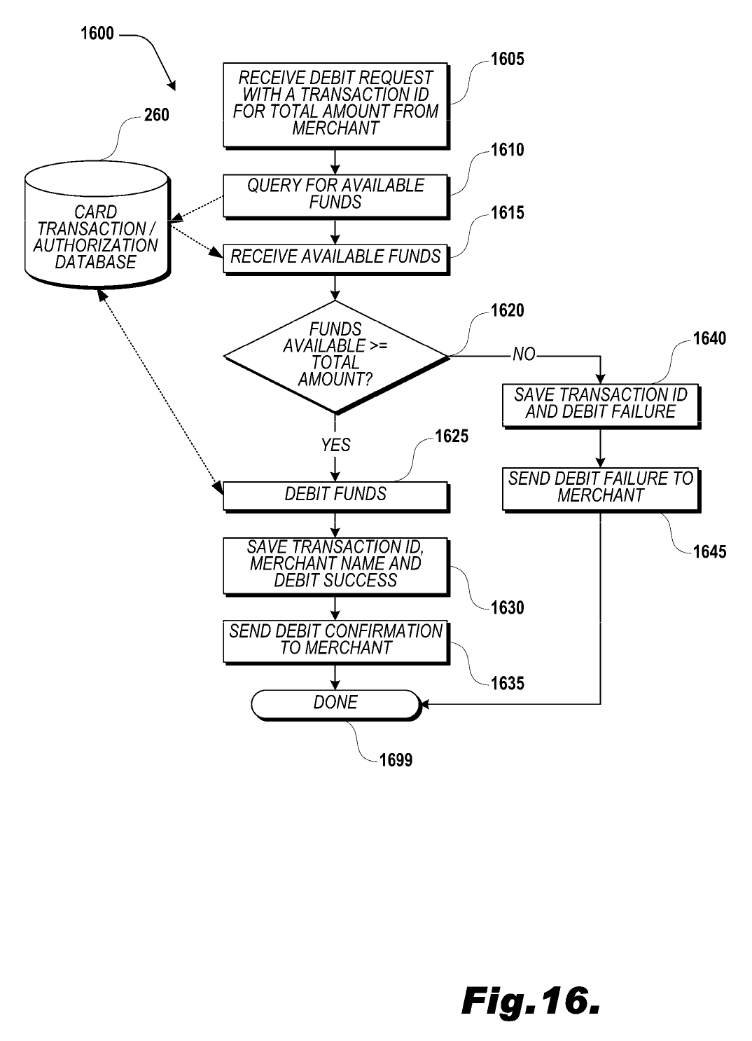

FIG. 16 illustrates an exemplary online payment transaction routine 1600 for purchasing goods and/or services from a merchant. Online payment processing routine 1600 begins at block 1605 where a debit request is received with a transaction identifier for a total amount from a merchant. In block 1610 a card transaction database 260 is queried for available funds and, in block 1615, the amount of available funds is received from the card transaction database 260. Next, in decision block 1620, a determination is made whether the available funds is at least equal to (i.e., equal to or greater than) the total amount received from the merchant. If so, processing proceeds to block 1625 where the funds are debited (or marked to be debited) from the card transaction database 260. In block 1630 the transaction identifier, a merchant name and the record of a successful debit transaction are saved. In block 1635 the debit transaction's completion is confirmed back to the merchant and processing ends at block 1699. If, however, in block 1620 it was determined that the funds are not at least equal to the total amount, processing proceeds to block 1640. In block 1640 the transaction identifier is saved along with an indication of a debit failure. An indication of the debit failure is sent back to the merchant in block 1645 and processing ends at block 1699. Those of ordinary skill in the art and others will appreciate that the online payment transaction routine 1600 is presented from the view of the card managing server 200. However, in further embodiments of the present invention, the card managing server 200 and the IPP server 1440 may be combined in a single device and, accordingly, further actions may be present in such an online payment transaction. Additionally, it will be appreciated that alternate embodiments of the present invention may include more, fewer or different actions than those illustrated in online payment transaction routine 1600. For example, in one additional embodiment, the query for available funds and the determination of whether the available funds are sufficient for the transaction may be combined in a single query to the database that includes the transaction total amount. Additional alternate embodiments will be apparent to those of ordinary skill in the art and others.

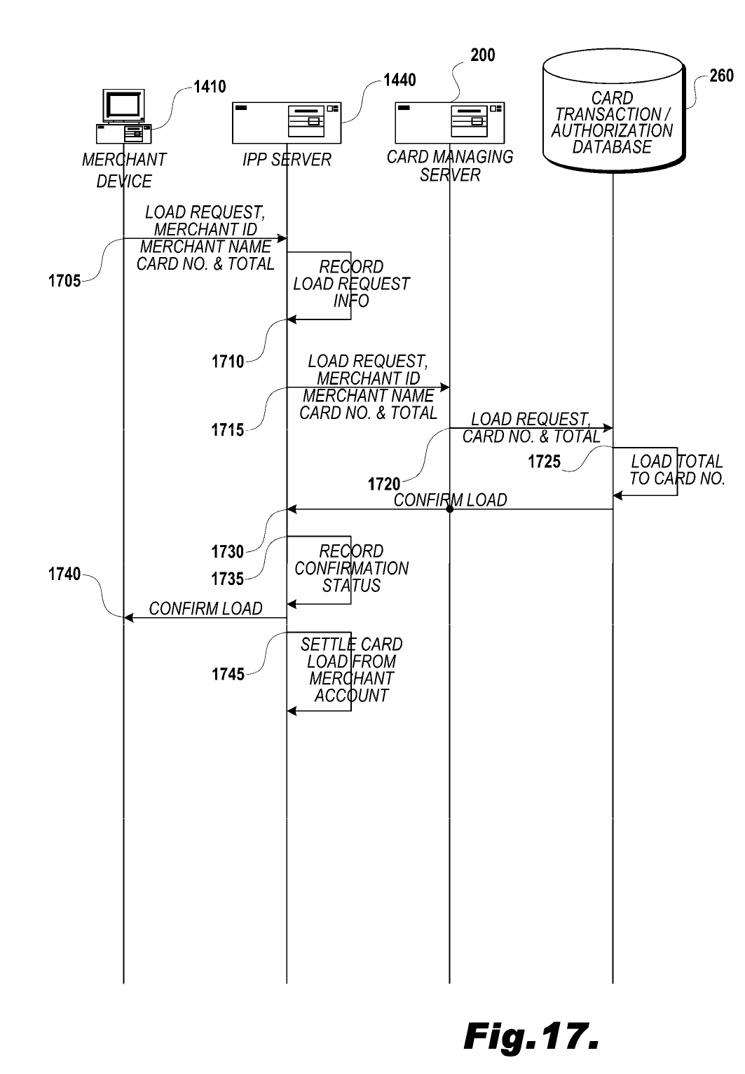

In addition to processing online payment transactions, embodiments of the present invention include a settlement mechanism for merchants whereby funds that have been settled to a “pool” account may be loaded onto loadable debit cards for use by the merchant and/or their designees. FIG. 17 illustrates the actions and communications between a merchant device 1410, IPP server 1440, card managing server 200 and a card transaction/authorization database 260 to provide funds to loadable debit cards of a merchant. The interactions begin with the merchant device 1410 submitting 1705 a load request, including a merchant identifier, merchant name, card number and a total load amount to the IPP server 1440. The IPP server 1440 records the load request information 1710 and submits 1715 the load request including the merchant identifier, merchant name, card name and total to the card managing server 200. The card managing server 200 submits a load request 1720 with the card number and total to the card transaction/authorization database 260. The card transaction/authorization database 260 loads 1725 the total amount to an account associated with the card number and returns a confirmation 1730, via the card managing server 200, to the IPP server 1440. The IPP server 1440 records 1735 the confirmation and confirms 1740 the load to the designated card to the merchant device 1410. The IPP server 1440 also settles 1745 the card load from the merchant's pool account.

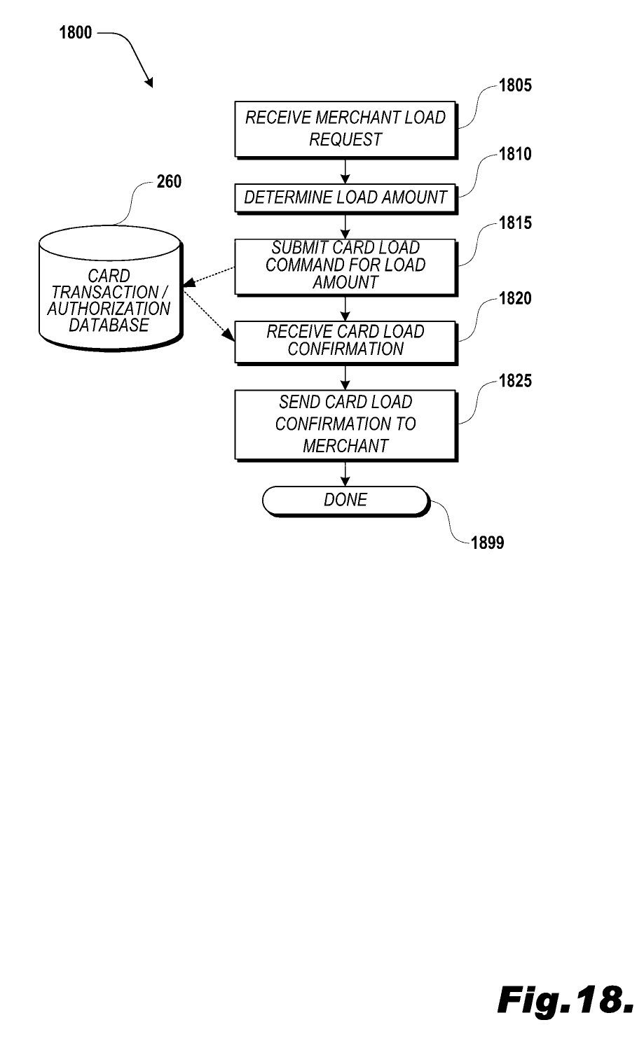

FIG. 18 illustrates an exemplary merchant load request routine 1800 for loading money from a merchant's pool account into a loadable debit card associated with the merchant and/or pool account. Merchant load request routine 1800 begins at block 1805 where a merchant's load request is received. In block 1810 the amount of the load request is determined. Next, in block 1815, a card load command is submitted for the determined load amount to the card transaction database 260. The card transaction database 260 confirms the loading of the card which is received in block 1820. Next, in block 1825, a card load confirmation is sent to the merchant and routine 1800 ends in block 1899.

Those of ordinary skill in the art and others will appreciate that additional actions may be used in further embodiments of the present invention when loading from a merchant pool account to a loadable debit card associated with a merchant and/or the pool account. For example, an additional query may be used to determine if a loadable debit card is actually associated with a particular merchant and/or pool account. Additionally, in further embodiments of the present invention, conventional authentication and security verifications are performed to maintain the security of the merchant's pool account. It will be appreciated by those of ordinary skill in the art and others that the card transaction/authorization database 260 may store additional information about a merchant's pool account and/or loadable debit cards. For example, the card transaction/authorization database 260 may have total load limits, daily load limits, load confirmation requirements and other restrictions on one or more loadable debit cards that may be associated with a merchant's pooled account. In other exemplary embodiments the merchant pool itself may have imposed limits that prevent certain load transactions by date, time, amount and the like.

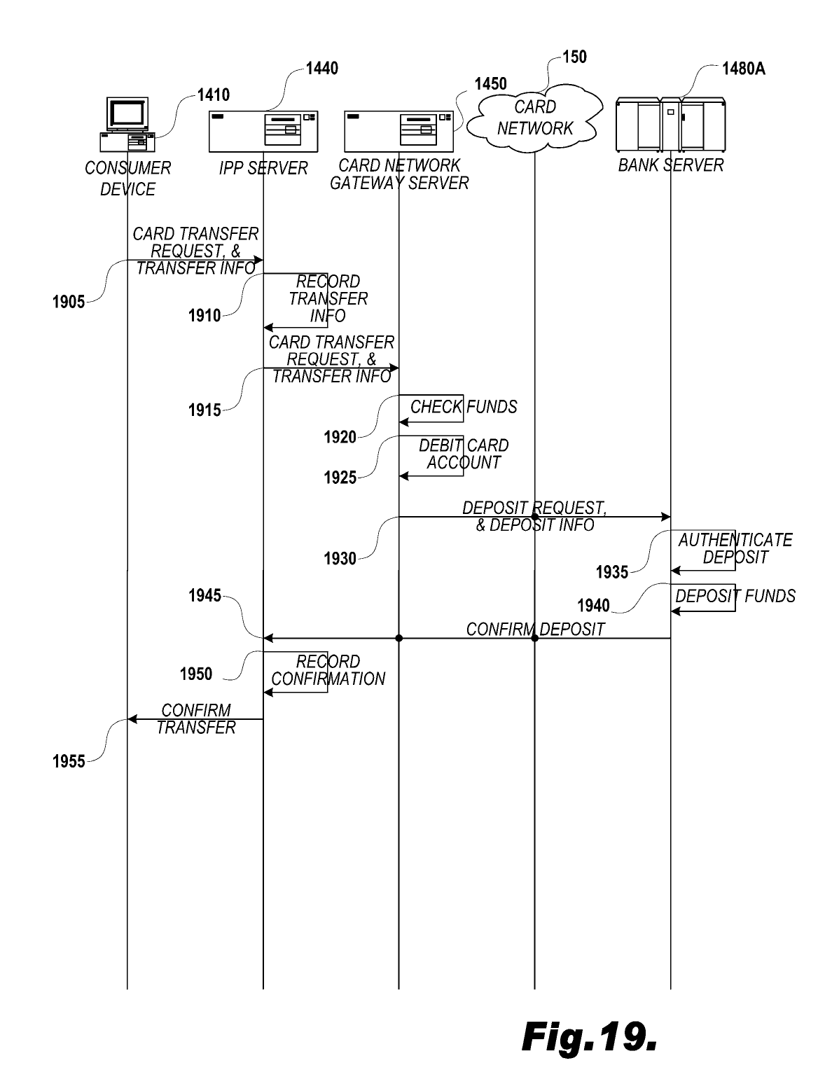

In addition to paying for goods and/or services with loadable debit cards and loading funds from a merchant into specified loadable debit cards, it is also possible to transfer funds from a loadable debit card to a conventional bank account (or to another loadable debit card account). FIG. 19 illustrates the actions and communications between a number of devices to transfer funds from a loadable debit card account to a bank account (or loadable debit card account) using a conventional debit card network 150. In FIG. 19, a user device 1410 initiates 1905 a card transfer request that includes transfer information to an IPP server 1440. The transfer information includes a card identifier, authentication information (such as a PIN, biometric information or the like) and a transfer amount. Those of ordinary skill in the art and others will appreciate that in other embodiments of the present invention a bi-directional communication between the user device 1410 and the IPP server 1440 may be used to iteratively gather this information, however in the illustrated embodiment in FIG. 19 such information is packaged in a single transfer request. Next, the IPP server 1440 records the transfer information 1910 (possibly without the authenticating information). The IPP server 1440 sends a card transfer request 1915 with the transfer information to the card network gateway server 1450. The card network gateway server checks for available funds 1920 in the account associated with the loadable debit card in the transfer information. Those of ordinary skill in the art and others will appreciate that, in one embodiment, such a transfer would be communicated to the card transaction/authorization database 260 for verification. In alternate embodiments of the present invention, fund availability information is available at the card network gateway server 1450. The card network gateway server 1450 next debits 1925 the card account associated with the loadable debit card identified in the transfer information for the request transfer amount. Next, the card network gateway server 1450 sends a deposit request 1930 with deposit information including the necessary deposit information to make a deposit for the amount deducted from the loadable debit card account via the card network 150 to a bank server 1480A. The bank server 1480A authenticates 1935 the deposit and deposits 1940 the funds into a specified account associated with the bank server 1480A. The bank server 1480 A confirms 1945 the deposit via the card network 150 and the card network gateway server 1450, to the IPP server 1440. The IPP server 1440 records the confirmation 1950 and confirms 1955 the transfer of funds back to the user device 1410. Those of ordinary skill in the art and others will appreciate that the actions and communications illustrated in FIG. 19 are merely illustrative examples of one exemplary embodiment of the present invention and that other actions and communications may be used to effectuate a transfer from a loadable debit card to a specified conventional bank account without departing from the spirit and scope of the present invention.

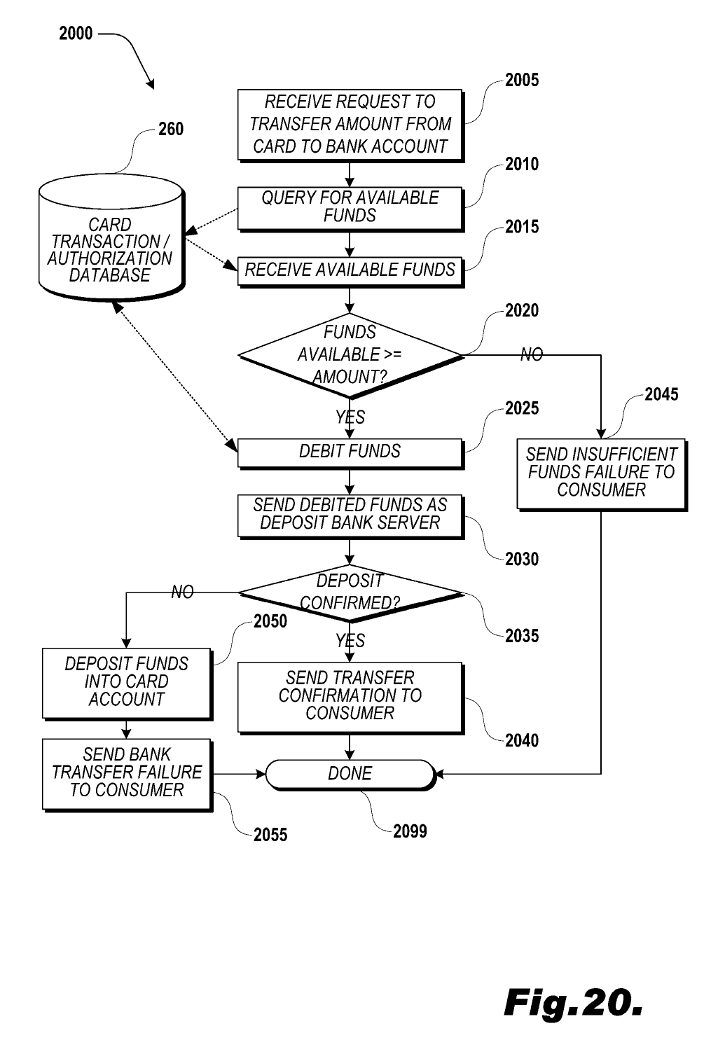

To better illustrate the operation of transferring funds from a loadable debit card to a conventional bank account FIG. 20 illustrates one exemplary card to bank account transfer routine 2000. Transfer routine 2000 begins at block 2005 where a transfer request is received to transfer an amount to a bank account. In block 2010 the card transaction database 260 is queried for available funds in the loadable debit card's account. The card transaction/authorization database 260 then returns the available funds in block 2015. In decision block 2020 a determination is made whether the funds are at least equal to the requested transfer amount. If so, in block 2025 the transfer amount is debited from the loadable debit card account at the card transaction/authorization database 260. In block 2030 the debited funds are sent as a deposit to a remote bank server with a designation of a particular bank account into which the funds should be deposited. In decision block 2035 a determination is made whether the deposit was confirmed from the bank server. If so, processing continues to block 2040 where a transfer confirmation is sent back to the user and transfer routine 2000 ends at block 2099. Returning to decision block 2020, if there are insufficient funds in the loadable debit card account, then in block 2045 an insufficient funds failure is sent to the user to let them know that the transfer was not successful and processing ends at block 2099. Similarly, if in decision block 2035 it was determined that there was not deposit confirmation, then in block 2050 the funds are redeposited into the loadable debit card account from which they were taken. Next, in block 2055 a bank transfer failure is sent to the user to indicate that the transfer was not successful and processing ends at block 2099.

Those of ordinary skill in the art and others will appreciate that the card transfer functions illustrated in FIGS. 19 and 20 allow for the transfer between a loadable debit card account and any other debit card account accessible from a user device 1410 (e.g., a personal computer, phone, automated teller machine, computer kiosk and the like).

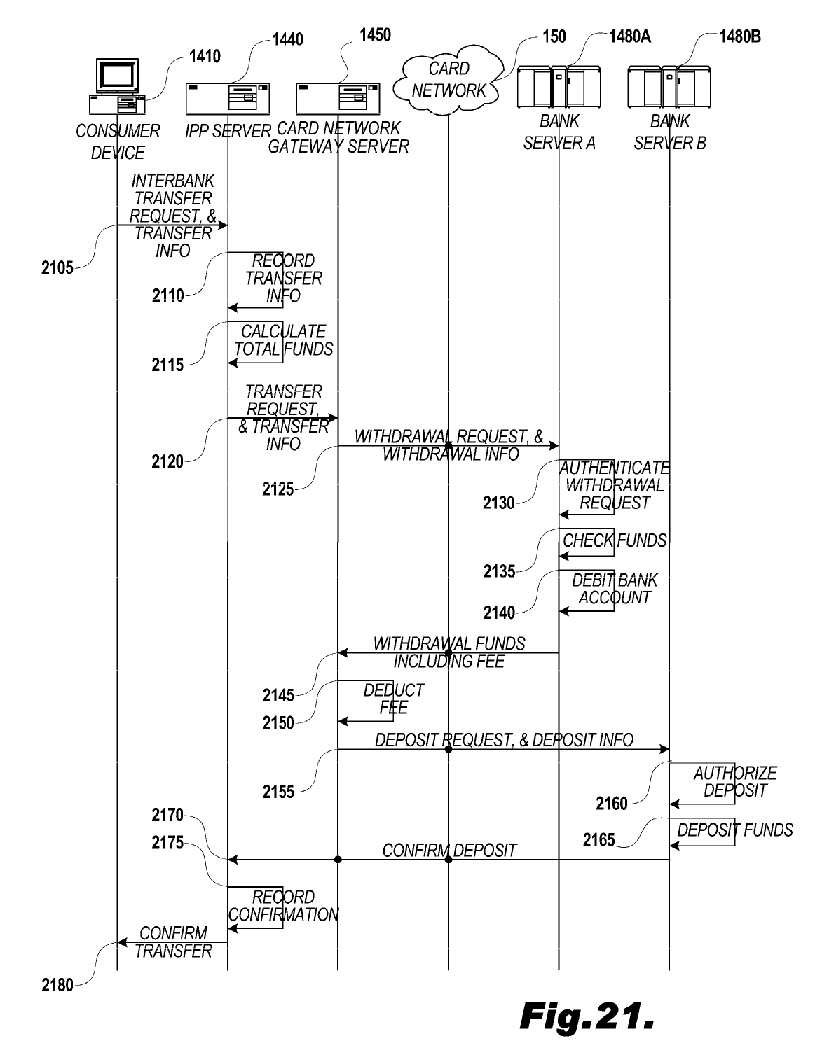

Similarly to the card to bank account transfer illustrated in FIGS. 19 and 20, further embodiments of the present invention allow the transfer of funds from one bank account to another bank account on a separate banking server (i.e., an inter-bank transfer) using a conventional debit card network 150. FIG. 21 illustrates the communications and actions between the user device 1410, IPP server 1440, card network gateway server 1450, card network 150, a first bank server A 1480A and a second bank server B 1480B. First, the user device 1410 initiates an inter-bank transfer request 2105 with transfer information (originating account, authorizing information for the originating account, a transfer amount, a destination account and authorization for the destination account) to the IPP server 1440. The IPP server records 2110 transfer information and calculates 2115 total funds needed for a transfer. The calculation of total funds needed for a transfer may include the addition of additional fees from a first bank A, a second bank B and the provider of the transfer service. Such additional fees may or may not also include card network fees and the like. The IPP server 1440 then sends the transfer request 2120 with transfer information (updated with the new total funds required and/or an indication of any additional fees to the card network gateway server 1450. The card network gateway server 1450 sends a withdrawal request 2125 including withdrawal information via the card network 150 to the first bank server A 1480A. The withdrawal information includes the necessary information to withdraw funds from bank server A (e.g., a bank account, authorizing information and an amount to withdraw). The bank server A 1480A authenticates 2130 the withdrawal request, checks for funds 2135 and debits 2140 a bank account with the requested amount (including any necessary fees calculated for the total transaction). The bank server A 1480A then sends the withdrawal funds 2145 back to the card network gateway server 1450. Card network gateway server 1450 then deducts 2150 any fees received. Next, the card network gateway server 1450 sends a deposit request 2155, including sufficient deposit information (e.g., an account, authorizing information and the necessary information to authorize the deposit of the remaining withdrawal funds), via the card network 150, to bank server B 1480B. Bank server B 1480B authorizes 2160 the deposit and deposits 2165 into the specified account. Bank server B 1480B then confirms the deposit 2170 via the card network 150, card network gateway server 1450 to the IPP server 1440. The IPP server 1440 records 2175 the confirmation and, in turn, confirms the inter-bank transfer 2180 to the user device 1410.

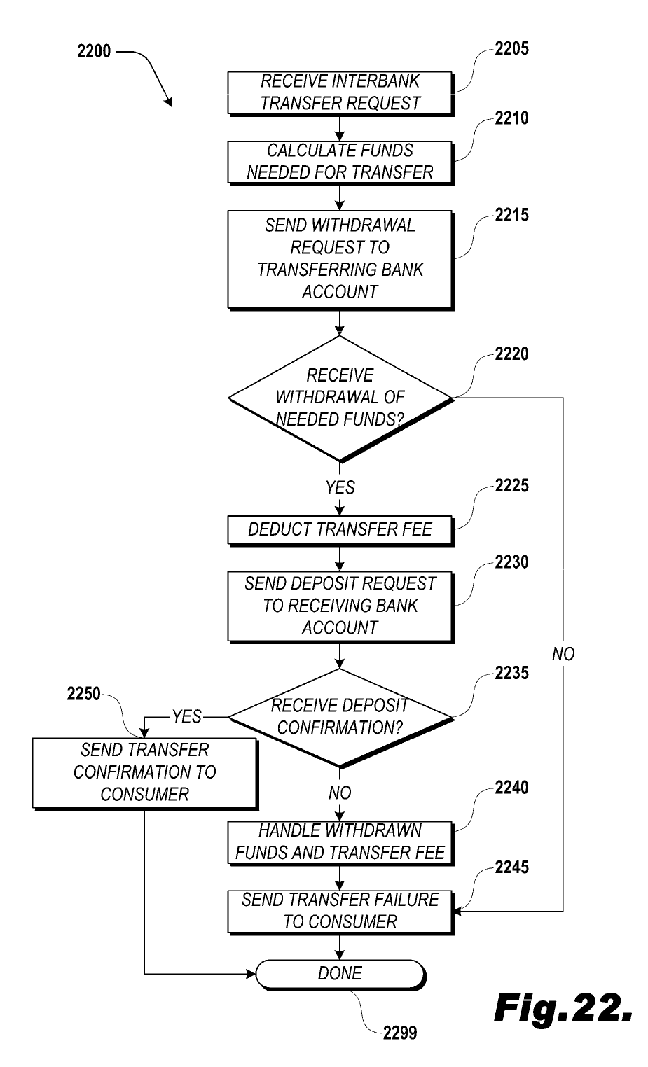

To better illustrate the inter-bank transfer of the present operation of the present invention FIG. 22 illustrates an inter-bank request routine 2200. Those of ordinary skill in the art and others will appreciate that the inter-bank request routine 2200 is performed substantially at the IPP server 1440 and/or the card network gateway server 1450. Inter-bank transfer routine 2200 begins at block 2205 where an inter-bank transfer request is received. In block 2210 the funds needed to complete the transfer are calculated, including any calculations of fees. Next, in block 2215 a withdrawal request is sent to the transferring bank account for the total funds needed to complete the transfer (i.e., the amount to be transferred plus any additional fee or fees). In decision block 2220 a determination is made whether the needed funds were withdrawn and received. If so, processing continues to block 2225 where the transfer fee (or fees) is deducted from the withdrawn amount. In block 2230 a deposit request is sent to a receiving bank account. In block 2235 a determination is made whether a deposit confirmation has been received back from the receiving bank account. If so, in block 2250, transfer confirmations are sent back to the user, originating bank and the transferring bank, inter-bank transfer 2200 ends at block 2299. If, however, in decision block 2235 it was determined that a deposit confirmation was not received then, in block 2240, the withdrawn funds and transfer fees are handled in an appropriate manner. In one exemplary embodiment of the present invention the transfer fee may be forfeited and the withdrawn funds are redeposited into the transferring bank account. In another embodiment of the present invention both the transfer fee and the other withdrawn funds are redeposited into the transferring bank account. Processing then proceeds to block 2245. Similarly, if in decision block 2220 it was determined that no withdrawal of the needed funds was received, processing also continues to block 2245 where a transfer failure is sent to the user. Inter-bank transfer routine 2200 then ends at block 2299.

In some embodiments it may be beneficial to integrate loadable debit cards with conventional banking transactions that are performed with conventional bank accounts. Accordingly, in some embodiments, a system (e.g., system 2300) may be implemented that allows for financial network transactions in addition to the transactions performed over a debit network. One such alternate network is the ACH network.

The ACH Network is a system used by financial institutions to process millions of financial transactions each day. The system utilizes a network of ACH associations, of which many major banks are members. The transactions take place in a batch mode, by financial institutions transmitting payment instructions through the system of clearing houses. As the pace of electronic commerce quickens, and with the price advantages of ACH payments versus other payment mechanisms such as checks and wire transfers, the volume of ACH transactions will likely continue to increase.

One common form of ACH transactions for users is the ACH credit, which is the transaction type used for direct deposit of payroll. In that transaction, the employer is the Initiator of an ACH credit (the Payor) and the employee is the Receiver (the Payee) of that ACH credit. ACH debits are becoming more prevalent for users, with some adopters being health clubs who debit their members' bank accounts for club dues. In that transaction, the health club is the Initiator (the Payee) of the ACH debit, and the member being debited is the Receiver (the Payor).

The ACH System is governed by rules, policies and procedures written by The National Automated Clearing House Association (“NACHA”). Under current NACHA Rules, the Originator of an ACH debit (the payee) must have proper authorization from the Receiver of the ACH debit (the payor) before such a transaction can be initiated.

“Unauthorized” debits can be returned; however, the timeframe in which this must be done is varies. Users, on the other hand, have the protection of Regulation “E” and specific NACHA Rules relating to User accounts, which allow users to return ACH debit entries (that they document as “not authorized”) for an extended period after the original transaction date. There is also a service that allows review of ACH debits before they are posted, with the customer making the decision to accept or return the debit individually.

One specific type of ACH transaction of interest is a WEB ACH transaction. The WEB ACH transaction is a debit entry to a user bank account, for which the authorization was obtained from the Receiver (the user who owns the bank account) over the Internet. The specific designation for these types of transactions was created in order to address unique risks inherent to Internet payments.

WEB entries require additional security procedures and obligations that address these risks.

Definitions Applicable to Web-Based Payments:

Originator: Service Provider creating the ACH debits (or requesting reversals).

Receiver: The person (for WEB transactions this may be a human being) who owns the bank account being debited.

ODFI: Originating Depository Financial Institution. Service Provider's bank.

RDFI: Receiving Depository Financial Institution. The Payer's bank.

PPD: Prearranged Payment and Deposit entry. An ACH debit or credit to a user bank account.

WEB: An ACH debit to a user account for which the authorization was provided via the Internet Authorization—For debit entries to user accounts, the authorization must be in writing and signed or similarly authenticated by the user. Written authorization can be provided electronically if the writing and signature requirements comply with the Electronic Signatures in Global and National Commerce Act (15 U.S.C. §7001 et seq.) which defines electronic records and electronic signatures. Generally speaking, this means that the authorization must be presented on a screen and in a form that can printed. Electronic signatures include, but are not limited to, digital signatures, PIN, password, shared secret, security codes, or a hard copy record may be authenticated via the telephone by the user's speaking or key-entering a code provided on the record. The authorization process should evidence both the user's identity and his assent to the authorization. The authorization should be clearly identifiable as an authorization, clearly and conspicuously state its terms and (with few exceptions) provide that the Receiver may revoke the authorization only by notifying the Originator in the manner specified in the authorization. It is important to note that authentication and authorization must occur simultaneously.

Prenotification: Prior to initiation of the first entry to a Receiver, an Originator may, at its option, send this type of transaction to “test” the routing of the ACH. “Live” entries can be initiated no sooner than six banking days following the settlement date of the prenotification.

These definitions are provided to illustrate the example embodiments described below, and are not meant to be limiting or exclusive of other reasonable interpretations of the example embodiments and claims.

In general, WEB transactions usually apply to user debits; however, one exception is a credit entry that is reversing a debit. WEB transactions may be used for both one-time and recurring debits (or reversals). Banks are not required to confirm that the account number and account name within an ACH transaction record match. Therefore, the liability for misrouted or fraudulent transactions sent to the wrong account number falls on the Originator.

In general, security of the Internet session equivalent to 128-bit encryption must be used from the point that the Receiver key enters their banking information through transmission of the data to the Originator. Additionally, availability of funds in the account cannot be determined before initiation of the ACH debit.

If an ACH debit is returned due to non-sufficient or uncollected funds in the Receiver's account, the return should posted to the ODFI (Service Provider's bank). The ACH Rules define when Settlement occurs. A user may notify their bank of an unauthorized ACH debit and may have it returned. Likewise, the RDFI may return the debit to the ODFI.

Banks have the right to post funds presented through the ACH network based on the account number alone. There is no requirement that an RDFI verify the name on the account matches the name on the ACH transaction.

Further details on the ACH system may be found in the 2005 ACH Operating Rules and Guidelines available from NACHA (National Automated Clearing House Association of Herndon, Va.), the entirety of which is hereby incorporated by reference. More specifically, multiple forms of ACH transactions are described therein that are suitable for use with various embodiments. An exemplary listing of transaction types includes, but is not limited to:
Accounts Receivable Entry (ARC) Consumer Cross-Border Payment (PBR)
Point-of-Sale Entry (POS) Prearranged Payment and Deposit Entry (PPD)
Point-of-Purchase Entry (POP)
Shared Network Entry (SHR)
Telephone-initiated Entry (TEL)
Internet-initiated Entry (WEB)
ACH Payment Acknowledgment (ACK)
Financial EDI Acknowledgment (ATX)
Corporate Cross-Border Payment (CBR)
Cash Disbursement (CCD)
Cash Concentration (CCD)
Corporate Trade Exchange (CTX)
Customer-initiated Entry (CIE)
Automated Accounting Advice (ADV)
Automated Notification of Change (COR)
Automated Return Entry (RET)
Death Notification Entry (DNE)
Automated Enrollment Entry (ENR)

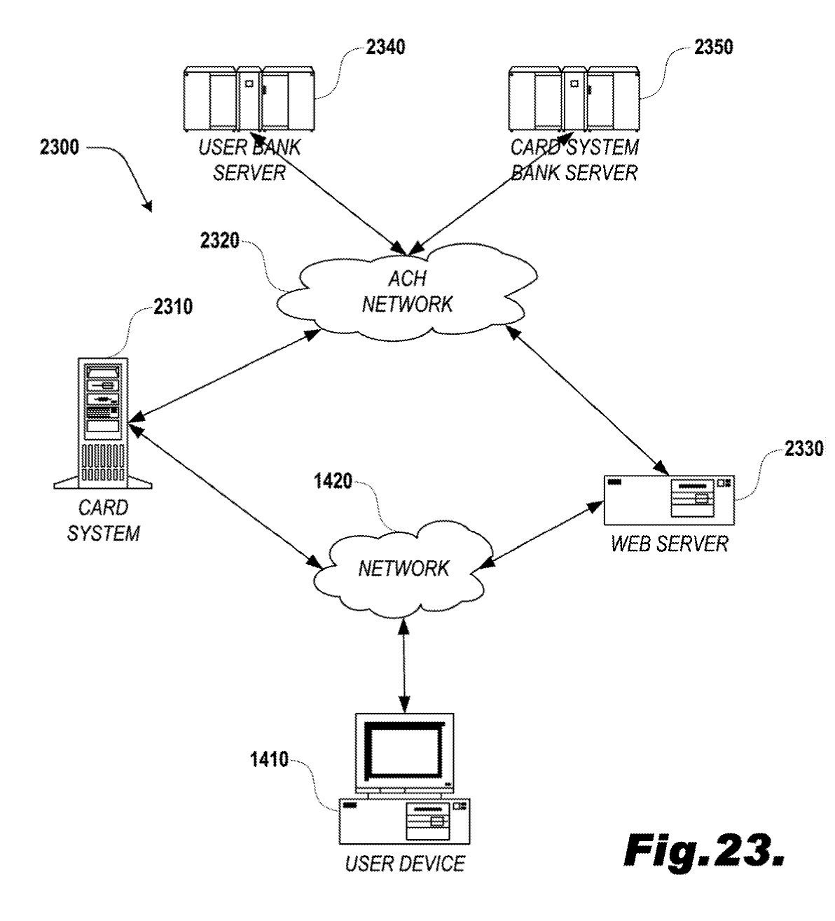

In a simplified overview of an ACH Network System for perform actions on a loadable debit cards account; FIG. 23 presents one exemplary embodiment of an ACH Transaction System 2300. FIG. 23 illustrates a user device 1410 connected via a network 1420 to a web server 2330 and a card system 2310. Both the card system 2310 and web server 2330 are connected to an ACH network 2320. Additionally a user bank server 2340 and card system bank server 2350 are also connected with the ACH network 2320.

In some systems, the card system 2310 may comprise one or more of the card network gateway server 1450, card-managing server 200, central account server 120 and IPP server 1440 and processing server 110. However, in alternate embodiments both more and less devices may comprise the card system 23100. The system 2300 shown in FIG. 23 is meant to illustrate one simplified embodiment of the present invention and is not meant to limit the actual implementations that embodiments may form. Accordingly, both more and less devices than those shown in FIG. 23 may be used in some embodiments.

FIG. 23 illustrates communications and interactions between user bank server 2340, ACH network 2320, card system bank server 2350 and card system 2310 to process ACH transactions. An ACH transaction shown in FIG. 15 begins with user bank server 2340 sending 2405 a file describing an ACH transaction (e.g., a NACHA file) via the ACH network 2320 to the card system bank server 2350. The card system bank server 2350 processes 2410 the NACHA file and extracts ACH data. Next, the card system bank server 2350 determines that at least some of the ACH data is associated with a settlement account 2415. The card system bank server 2350 sends the associated ACH data 2420 to the card system 2310. The card system 2310 processes 2425 the ACH data and identifies 2330 the card account (S) that the ACH data relates to. The card system bank server 2350 then reconcile 2435 the ACH data and actions to be performed on the data. The card system bank server 2350 then performs and ACH action 2440 on a settlement account associated with the card system 2310. Likewise, the card system performs an ACH action 2445 on the identified card account. (Note: Make action from this Figure singular no plural).

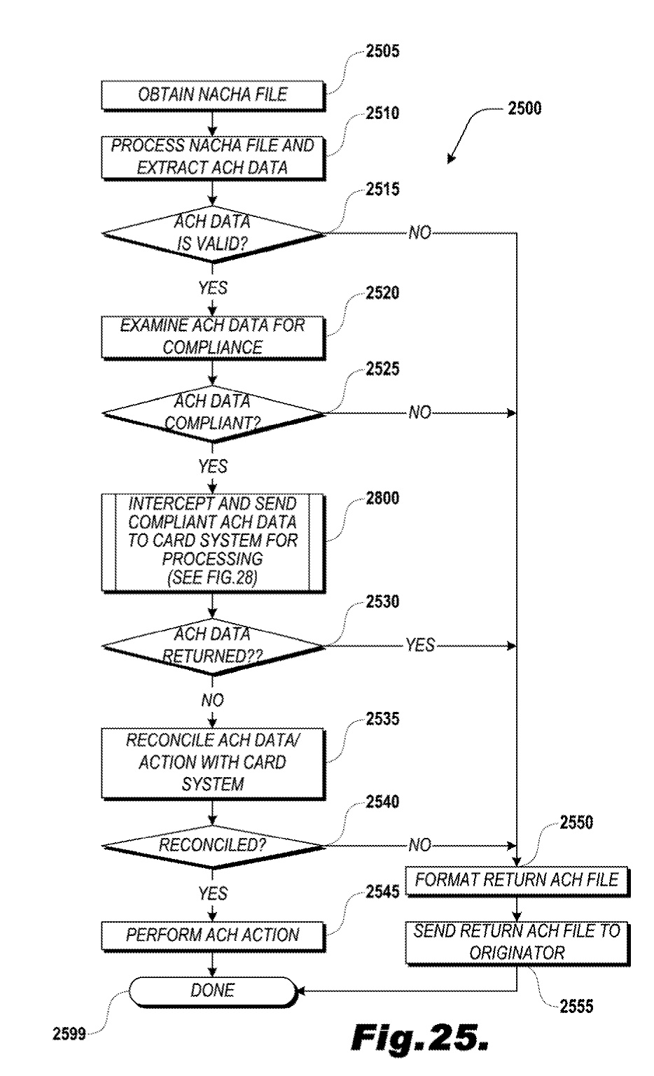

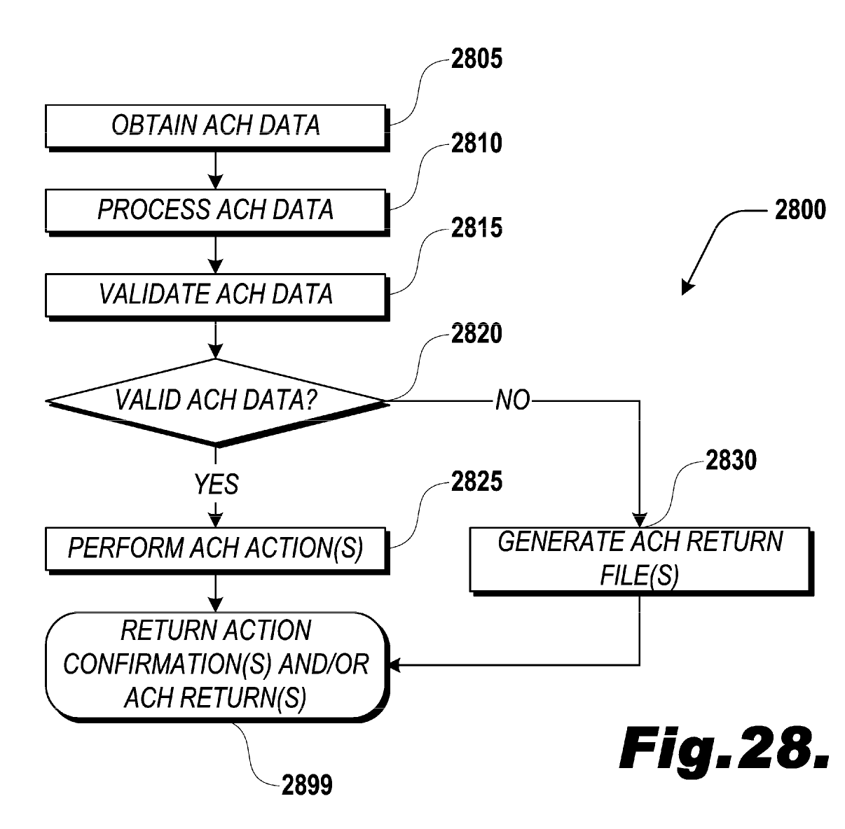

FIG. 25 illustrates an exemplary ACH transaction processing routine 2500 on a bank server. ACH transaction processing routine 2500 begins at block 2505 where a NACHA file is obtained. In block 2510, the NACHA file is processed and ACH data is extracted. Next, in decision block 2515, a determination is made whether the ACH data is valid data. If the ACH data is determined in decision block 2515 not to be valid processing proceeds to block 2550 as described below. If the ACH data is valid, processing proceeds to block 2520 where the ACH data is examined for compliance with a card system. Likewise if the data is found not be compliant then processing proceeds to block 2550. If, however, in decision block 2525 it was determined that the ACH data is compliant then processing proceeds to subroutine block 2800 where the ACH data is intercepted and sent to a card system for processing. Subroutine 2800 is illustrated in FIG. 28 and described below.

Upon returning from subroutine 2800, processing continues to decision block 2530 where a determination was made whether the ACH data was returned from the card system. If the ACH data was returned then processing continues to block 2550. If however the ACH data was not returned as determined in decision block 2530, processing proceeds to block 2535 where the ACH data and action are reconciled with the card system (e.g., card system 2310). In decision block 2540, after a termination is made whether the ACH data and/or actions were reconciled with the card system. If the reconciliation was not successful then processing proceeds to block 2550, where a return ACH file is formatted and in block 2555, the return ACH file is sent back to the originator of the ACH transaction. Afterwards processing proceeds to block 2599. If, however, in decision block 2540 it was determined that the card system reconciled successfully then in block 2545, the described ACH action is performed and processing proceeds. Next, processing proceeds to block 2599 where ACH transaction processing routine 2500 ends.

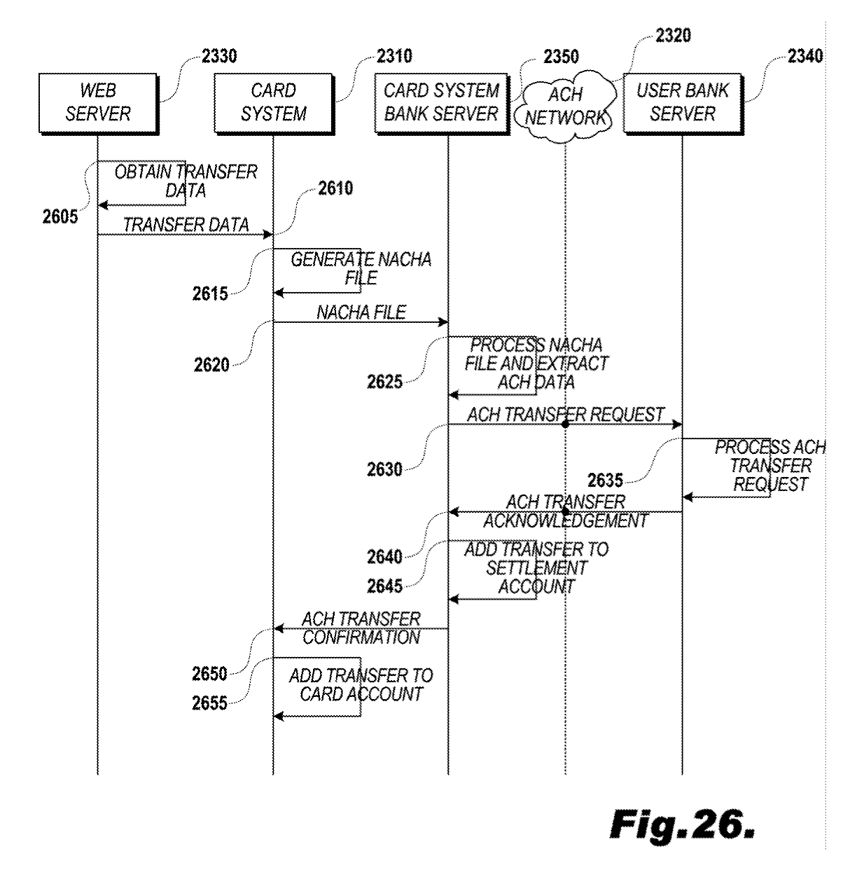

FIG. 26 illustrates the actions and communications between a web server 2330, card system 2310. Card system bank 2350 ACH network 2320 and user bank server 2340 for transferring funds either to or from a user's bank account on the user bank server 2340 to a loadable debit card associated with card system 2310. The interactions begin with the web server 2330 obtaining 2605 transfer data. The web server 2330 sends 2610 the transfer data to the card system 23M. The card system 2310 generates 2615 a NACHA file and sends 2620 the NACHA file to the card system bank server 2350. The card system bank server 2350 processes 2625 the NACHA file and extracts ACH data. The card system bank server 2350 sends 2630 an ACH transfer request via the ACH network 2320 to the user bank server 2340. The user bank server 2340 processes 2635 the ACH transfer request and returns 2640 and ACH transfer acknowledgment. The card system bank server 2350 adds (or subtracts) the transfer amount 2645 from a settlement account at the card system bank server 2350. The card system bank server 2350 sends 2650 an ACH transfer confirmation to the card system 2310. The card system 2310 then adds (or subtracts) the transfer 2655 amount to the designated card account. It will be appreciated by those of ordinary skill and the art that the ACH transfer confirmation includes information designating a card account.

In various embodiments, each loadable debit card contains a BIN (Bank Identification Number) which designates that specific cards account. Accordingly, this BIN may be used in some embodiments to determine where to route ACH transactions involving a loadable debit card. In one specific embodiment, the BIN is associated with a card system bank, but the BIN further includes an identification of the card system 2310 such that the card system bank 2350 may intercept the processing of ACH transactions involving such specific BINS and forward them to the card system for additional processing.

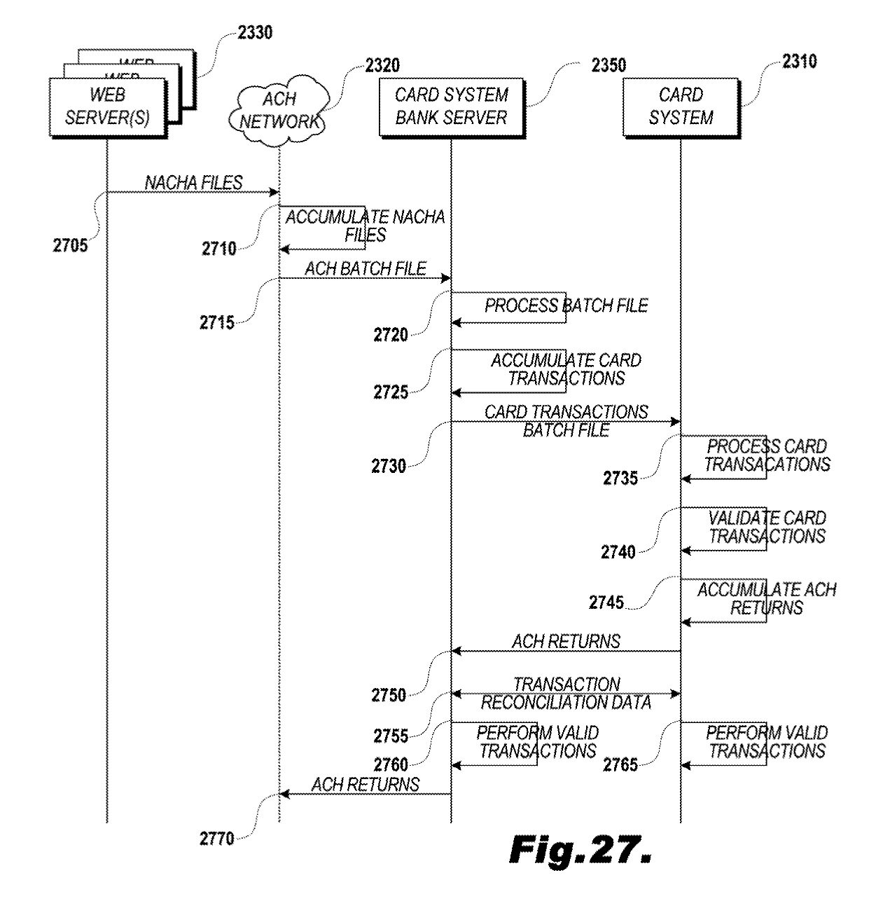

FIG. 27 illustrates the actions and communications between web server 2330 and ACH network 2320, card system bank server 2350 and card system 2310 to process multiple ACH transactions directed to loadable debit cards associated with the card system 2310. The interactions begin with the web servers 2330 sending 2704 NACHA files to the ACH network 2320. Devices (not shown) within the ACH network 2320 accumulate 2710 the NACHA file and send 2715 an ACH batch file (containing one or more transactions) to the card system bank server 2350. The card system bank server 2350 processes 2720 the batch file and accumulates 2725 card transactions that are intercepted from processing solely at the card system bank server 2350. The intercepted card transactions are sent 2730 as a batch file to the card system 2310. The card system 2310 processes 2735 the card transactions and validate 2740 the card transactions. Valid card transactions will be further processed and reconciled, however invalid transactions are to be returned to their originator. Accordingly, the card system 2310 accumulates 2745 ACH returns (e.g., invalid transactions). The card system 2310 sends 2750 the ACH returns back to the card system bank server 2350 for processing and return to their originator. Additionally the card system bank server 2350 and card system 2310 reconcile the valid transactions. The card system bank server 2350 performs valid ACH transactions on the card systems settlement account at the card system bank server 2350. Likewise, the card system 2310 performs valid transactions relating to identified loadable debit cards accounts in the card system 2310. The card system bank server also sends 2770 the ACH returns to the ACH network 2320 for return to their originator.

As introduced above, FIG. 28 illustrates an exemplary ACH transaction processing routine 2800 for processing ACH data at the card system 2320. ACH data processing begins at block 2805 where ACH data is obtained. In block 2810, the ACH data is processed and respective card accounts in the card system 2310 are identified. In block 2815, each piece of ACH data is validated. If any transaction contains invalid data then in decision block 2820 processing proceeds to block 2830 where an ACH return file is created. Note that with multiple invalid ACH transactions multiple ACH return files may be created. For all data that is determined in decision blocks 2820 to be valid ACH data than in block 2825 the ACH actions are performed. In return block 2899, subroutine 2800 returns action confirmation(s) and/or any ACH return file(s) to the calling routine.

In some embodiments, “gift” (or merchant/location/purpose/etc.) cards may be funded via an open-loop debit/credit network. Such gift cards can offer payments for a specific merchant location, and may be funded through existing POS device 300 via an open-loop network (i.e., standard debit/credit network). No specific gift card terminal and/or application is required for the card funding. Transactions pass from a merchant's POS device to merchant acquirer bank/processor; then to network to card issuer. The open-loops network will do the settlement on behalf of merchant. Card funding in this method can be used at funding locations; and the card issuer may control card transaction authorization at back end. If the merchant wants to allow ATM withdrawal in his gift card program, issuer will allow those transactions. If the merchant wants to give any special discount to the card holder for rechargeable gift card, the card issuer may do that for the merchant.

Exemplary Gift Card Platform:

One exemplary gift card processing platform is designed to accommodate the present and future market demands of gift card applications. The exemplary gift card platform is scalable and flexible enough to support gift cards for “brick and mortar” stores, large Chain store, shopping malls, geographic regions and many other merchant groupings/configurations. Such exemplary programs can offer a many variations of gift card program using the exemplary gift card platform. Gift cards may be offered in a variety of fashions, including:

(1) Open-loop Funded Open-loop Gift Card program

(2) Closed-loop Funded Open-loop Gift Card program

Open-loop Funded Open-loop Gift Card:

Gift card via open-loop provides a flexible way to offer gift card services to merchant partners. Open-loop gift cards are re-loadable gift cards, but it can also be used as a one-time gift card like traditional gift card. In an open-loop environment, open-loop gift card can be used only at authorized merchant locations. Authorized merchant locations can be restricted or controlled based on:
Single merchant
Group of merchants
Single category of merchants
Multi-category of merchants
Single Chain-store
Multi-Chain-Stores
Single shopping Mall
Multi-Shopping Malls
. . . and the like

Open-loop gift card can also be used as a Loyalty card like a combo card. Loyalty value on card accounts can be derived from:
Number of transactions
Total value of dollar spending
Frequency of reuse of cards
Total dollar spending on particular type of goods
Number of visits on a particular merchant location within a certain period
. . . and the like

Depending on the merchant's (or other grouping usable by the debit card) redemption policy, customers' earned loyalty value can be redeemed after certain threshold value or after certain period via batch or real-time process. Merchant specific open-loop gift card program can also be set for limited ATM withdrawals.

Funding Methods:

Open-loop gift cards can be funded in two ways:

(1) Open-loop funding process

(2) Closed-loop funding process

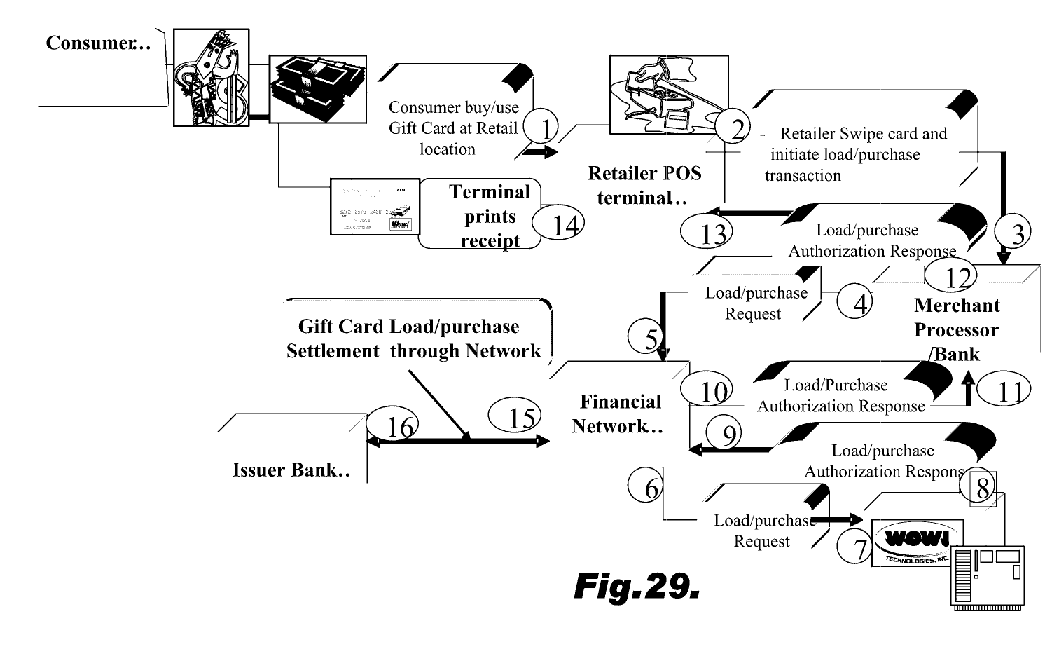

In an open-loop funding process, a merchant may use a loadable debit funding method (e.g., debit-return) to fund open-loop gift card, such as one of the methods described above. A merchant may not require any additional terminal and/or terminal application to fund open-loop gift card. Merchants may use their existing terminals to fund such an open-loop gift card. In the open-loop funding process, funding request transaction will flow from merchant POS device to merchant acquirer to standard debit network to card issuer processing platform, and funding confirmation/decline transaction will flow at opposite order of funding request. Please see FIG. 29 for details.

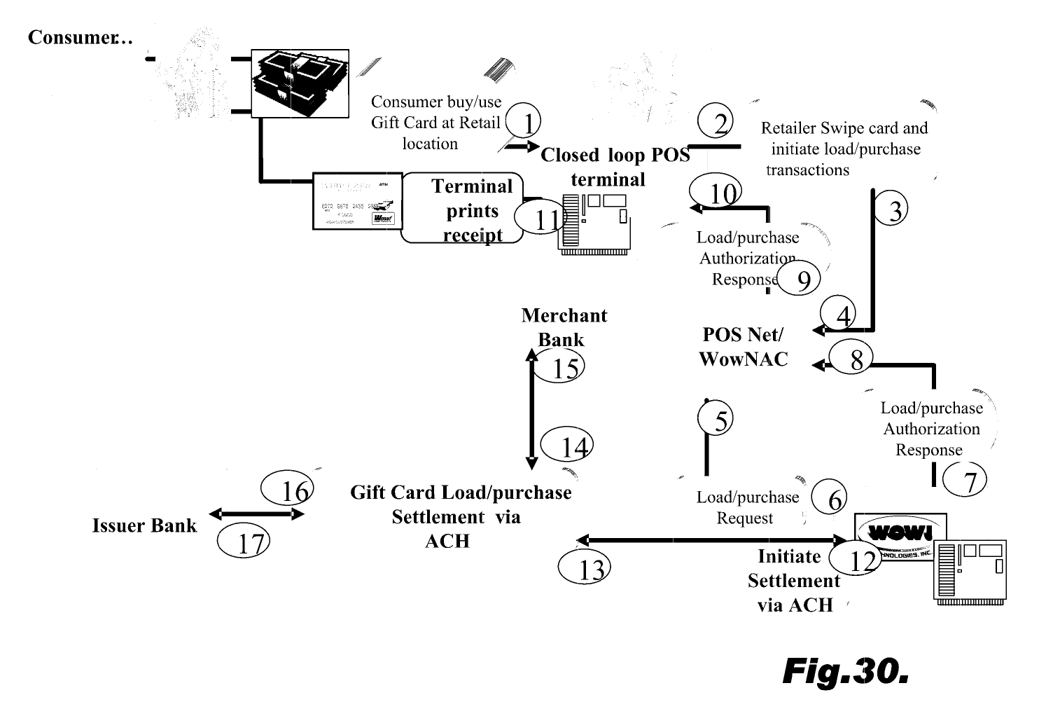

In Closed-loop funding process, a merchant has to use a closed-loop terminal or terminal application to fund the open-loop gift card. In exemplary closed-loop funding processes, funding transactions will flow directly between merchant POS device and a gift card issuer processing platform. See the exemplary process shown in FIG. 30 for more details.

Card Usage Security Features:

Open-loop gift cards have additional security features when compared to conventional closed-loop gift cards. Open-loop gift cards may be used at any authorized merchant locations, but allow customers to protect their cards with a PIN or signature validation to approve the transaction. Closed-loop gift cards generally do not require/allow signature or PIN validation to use the card.

Account Access via Web or IVRU:

In some embodiments, open-loop gift card users can login to their gift card account via a Website or using an IVRU using special access information, which is generally different from their PIN. Open-loop gift cardholders may be able perform the following transactions using IVRU and Web in some embodiments:
Fund transfer from one open-loop gift card to another open-loop gift card
Account balance
Transaction history
PIN and password changes via IVRU
Address update via Web

Software and Hardware Requirements at Merchant Locations:

In open-loop funding methods, a merchant does not require any additional terminal or terminal application as long as they support debit-return in their terminals. Open-loop gift cards may be funded via a debit-return process as described above.

In closed-loop funding method of open-loop gift card, a merchant should have a closed-loop POS device and associated terminal application to fund the open-loop gift card. Merchants may also use a PC POS application to fund open-loop gift card.

Online Report:

In some embodiments, it is possible to allow merchants to access to monitor the gift card transaction activity of particular merchant locations. For example, a corporate headquarters of a chain store or group of merchants would be able to monitor the activity of each individual store location. Merchant could also get the reconciliation account balance information of their merchant account through Web access.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

What is claimed is:

1. A computer implemented method of loading a loadable open-loop gift card as shown and described.

2. An open-loop gift card as shown and described.
